(19) United States
(12) Patent Application Publication
(10) Pub. No.: US 2026/0012677 A1
(43) Pub. Date: Jan. 8, 2026

(54) SYSTEMS, METHODS, AND APPARATUSES FOR ENHANCING AUDIO IN A RECORDED VIDEO

(71) Applicant: Soundshop Music Inc., Washington, DC (US)

(72) Inventors: Charles DARBY, Washington, DC (US); Ivan VICAN, Zagreb (HR)

(73) Assignee: Soundshop Music Inc., Washington, DC (US)

(21) Appl. No.: 19/262,929

(22) Filed: Jul. 8, 2025

Related U.S. Application Data
(60) Provisional application No. 63/668,665, filed on Jul. 8, 2024.

(51) Int. Cl. H04N 21/43; G06F 3/04817; H04N 21/439; H04N 21/454; H04N 21/845

(52) U.S. Cl. CPC H04N 21/43072; G06F 3/04817; H04N 21/4394; H04N 21/454; H04N 21/8456

(57) ABSTRACT

A computer-implemented method, apparatus, and system is provided for enhancing audio. The method may include: receiving audio portion data of a recorded video, the audio portion data comprising non-media sounds and media sounds; determining reference media data for the media sounds in the audio portion data of the recorded video; generating synchronized media data based at least on the reference media data and the media sounds in the audio portion data, the synchronized media data being synchronized to the media sounds in the audio portion data; providing, to a device, at least one of the synchronized media data or data based on the synchronized media data for combining the synchronized media data and the audio portion data to obtain an enhanced video.

### CROSS-REFERENCE TO RELATED APPLICATIONS

This application claims the benefit of U.S. Provisional Application No. 63/668,665, filed Jul. 8, 2024, which is hereby incorporated by reference in its entirety.

### BACKGROUND

Smartphone users record millions of videos featuring background music at parties, sporting events, & numerous other social settings where music is played over speakers. The sound quality of the background music in these videos is poor due to factors including but not limited to challenging recording conditions, underequipped smartphone microphones, and varying quality of speakers. Users post these videos to social media platforms like TikTok® and Instagram® where the dull and distorted sound quality negatively affects the entertainment value of billions of video views.

### SUMMARY

The following summary is merely intended to be an example. The summary is not intended to limit the scope of the claims.

In accordance with one aspect, a computer-implemented method for enhancing audio, the method may comprise: receiving audio portion data of a recorded video, the audio portion data comprising non-media sounds and media sounds; determining reference media data for the media sounds in the audio portion data of the recorded video; generating synchronized media data based at least on the reference media data and the media sounds in the audio portion data, the synchronized media data being synchronized to the media sounds in the audio portion data; providing, to a device, at least one of the synchronized media data or data based on the synchronized media data for combining the synchronized media data and the audio portion data to obtain an enhanced video.

In accordance with another aspect, a computer-implemented method for enhancing audio, the method may comprise: receiving audio stream data, the audio stream data comprising non-media sounds and media sounds; determining reference media data for the media sounds in the audio stream data; generating synchronized media data based at least on the reference media data and the media sounds in the audio stream data; and providing, to a device, at least one of the synchronized media data or data based on the synchronized media data to obtain an enhanced video.

In yet another aspect, a computer-implemented method for enhancing audio, the method may comprise: generating or obtaining a recorded video, the recorded video comprising audio portion data and video portion data, the audio portion data comprising non-media sounds and media sounds; receiving at least one of: reference canceled audio data, the reference canceled audio data based on the media sounds of the audio portion data and synchronized to the audio portion data of the recorded video; or reference enhanced audio data, the reference enhanced audio data based on the media sounds of the audio portion data and synchronized to the audio portion data of the recorded video; adjusting audio of the recorded video based on at least one of the reference canceled audio data or the reference enhanced audio data to obtain enhanced audio; and generating an enhanced video based on the recorded video and the enhanced audio.

### BRIEF DESCRIPTION OF THE DRAWINGS

FIGS. 1A-1C depict an example flowchart depicting a method for enhancing audio in a recorded video according to one or more embodiments described herein.

FIGS. 2A and 2B depict an example flowchart depicting a method for enhancing audio in a recorded video using an enhancement adaptive filter according to one or more embodiments described herein.

FIG. 3 depicts an example user interface on a user device according to one or more embodiments described herein.

FIG. 4 depicts an example user interface on a user device according to one or more embodiments described herein.

FIG. 5 depicts an example computer apparatus for use with the embodiments described herein.

### DETAILED DESCRIPTION

As discovered by the inventors, a recorded video with poor audio may be processed by computer-based techniques to improve the poor audio and obtain an enhanced video. As an example, a user may record a video on their device, such as their smartphone, or the like, and the audio stream in the recorded video may be enhanced in near real time using computer-based techniques discovered by the inventors and described herein. The poor audio may be due to, for example, challenging recording conditions, underequipped device microphones, varying quality of speakers, or a combination thereof. The poor audio may be a combination of one or more people speaking, singing, laughing, shouting, and/or yelling, crowd noise, live performances, and/or media playing such as music, movies, television shows, podcasts, radio shows, sporting events, broadcasts, speeches, news presentations, social media videos, sound effects, and/or live streams. In some embodiments, the computer-based techniques described herein separate non-media sounds (e.g., human sounds, one or more people speaking, singing, laughing, shouting, and/or yelling, and/or crowd noise) from media sounds (e.g., music, live performances, movies, television shows, podcasts, radio shows, sporting events, broadcasts, speeches, news presentations, social media videos, sound effects, and/or live streams). In some embodiments, the media sounds may be background sounds compared to the non-media sounds. Once separated, the non-media sounds and the media sounds may be enhanced separately and then recombined to obtain an enhanced video file. In some embodiments, a user may select one or more variables for enhancing the non-media sounds and/or the media sounds. In some embodiments, a user may select one or more variables for recombining the enhanced non-media sounds and/or the enhanced media sounds to obtain an enhanced video.

One or more embodiments described herein provide a practical application of improving audio with poor quality in a recorded video. Recorded video with poor audio may be distracting and/or displeasing to a viewer and may deter the viewer from watching the entire recorded video, re-watching the recorded video, and/or recommending others to watch the recorded video.

Further, one or more embodiments described herein address the technical problem of improving audio with poor quality in a recorded video. When a user records a video on, for example, a smartphone, the user typically uses the microphone(s) of the smartphone to capture audio for the video. The captured audio may be of poor quality, and the user may be desirous of improving the poor audio of the recorded video. In some embodiments, the recorded video with the poor audio may be recorded by the user or may be obtained by the user. As an example, the recorded video with the poor audio may be obtained by the user by accessing local storage (e.g., memory on a smartphone), downloading the recorded video, accessing a database of recorded video, receiving the recorded video in a message (e.g., via email, text, or app), and/or obtaining the recorded video from an app.

To address the technical problem, one or more embodiments described herein provide a technical solution of using computer-based techniques to separate non-media sounds from media sounds in the audio of a recorded video. With the technical solution, once the non-media sounds and the media sounds are separated, the non-media sounds and the media sounds may be enhanced separately and then recombined to obtain an enhanced video. In some embodiments, enhancing the separated audio streams and/or recombining the separated enhanced audio streams may include user-selectable options. Due to the amount of data and complexities of the signal processing involved in performing the operations needed for the technical solution, this technical solution cannot be performed by a human mind and, instead, must be performed using computer-based techniques.

In some embodiments, a user may interact with an app on their device (e.g., their smartphone) to enhance audio of a recorded video. The app may use Automatic Reference Enhancement (ARE) computer-based techniques described herein to enhance the audio. ARE may be comprised of four stages: Stage 1, recognition; Stage 2, synchronization; Stage 3, cancellation; and Stage 4, enhancement.

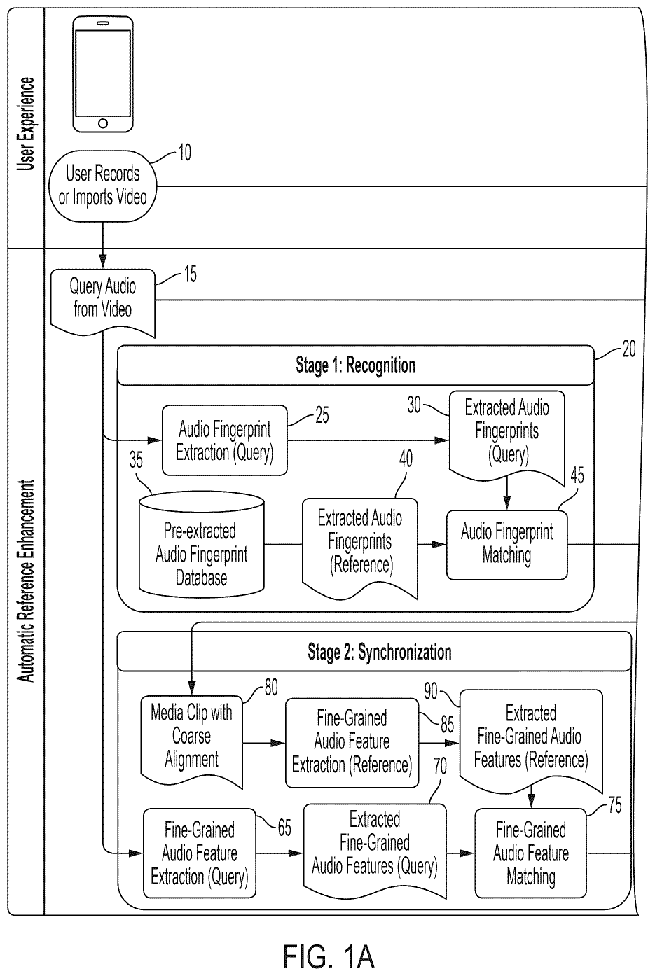

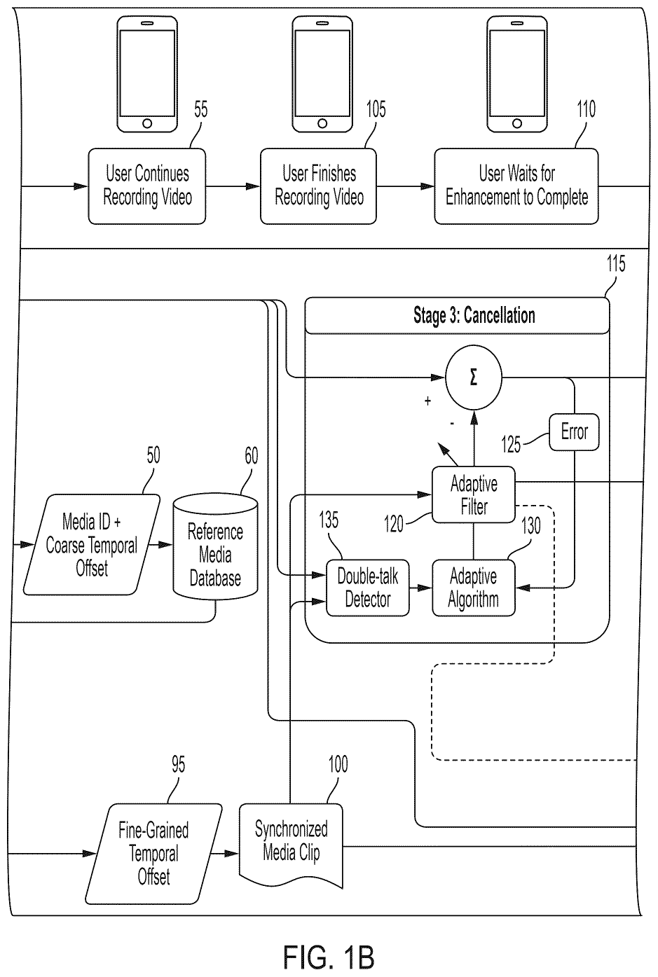

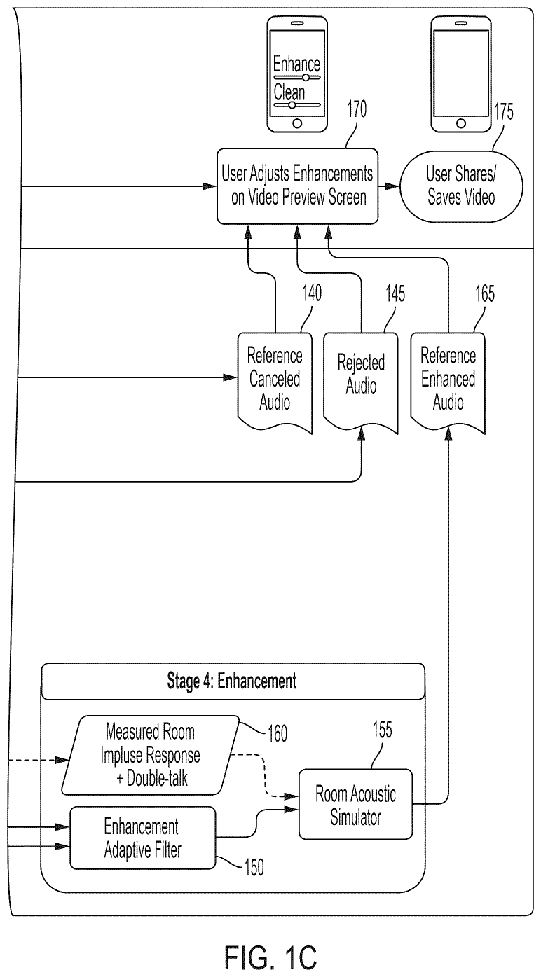

FIGS. 1A-1C depict an example flowchart depicting a method for enhancing audio in a recorded video according to one or more embodiments described herein. In particular, FIGS. 1A-1C illustrate the progression of the four stages of ARE as the user enhances audio in the recorded video within the app. User actions are represented in the top row (“User Experience”), and ARE logic is represented in the bottom row (“Automatic Reference Enhancement”).

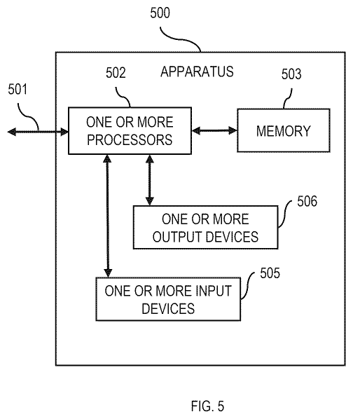

In some embodiments, certain steps of the method of FIGS. 1A-1C may be computer-implemented steps. The method of FIGS. 1A-1C may be implemented by any suitable system or apparatus, such as apparatus 500 of FIG. 5. As an example, multiple apparatuses may be used. For example, first apparatus 500 may handle the portion of the method in the top row (“User Experience”), and second apparatus 500 may handle the portion of the method in the bottom row (“Automatic Reference Enhancement”). The scope of the disclosure is not limited to the process division of first apparatus 500 handling the portion of the method in the top row (“User Experience”) and second apparatus 500 handling the portion of the method in the bottom row (“Automatic Reference Enhancement”) as depicted in FIGS. 1A-1C, and other process divisions using one or more apparatuses 500 will be understood by one of ordinary skill in the art and are covered by the disclosure herein. As an example, first apparatus 500 and second apparatus 500 may divide the portions of the method of FIGS. 1A-1C differently than the top row and the bottom row of FIGS. 1A-1C. As an example, single apparatus 500 may perform the method of FIGS. 1A-1C. As an example, one, two, three, four, or more apparatuses 500 may perform various portions of the method of FIGS. 1A-1C.

While an order of operations is indicated in FIGS. 1A-1C for illustrative purposes, the timing and ordering of such operations may vary where appropriate without negating the purpose and advantages of the examples set forth in detail.

FIGS. 1A-1C include various symbols representing aspects of the method for enhancing audio. A round rectangle (e.g., 25, 45, 55, 85, etc.) or an oval (e.g., 10, 175) may represent a step in the method. A cylinder (e.g., 35, 60) may represent a database. In some embodiments, the database may be stored locally or accessible over a network. A parallelogram (e.g., 50, 95, etc.) may represent data (e.g., a data value, such as a number or an identification, etc.). A rectangle with a bottom wavy line (e.g., 15, 30, 40, 100, etc.) may represent data (e.g., an audio data file, data derived from another data file, etc.).

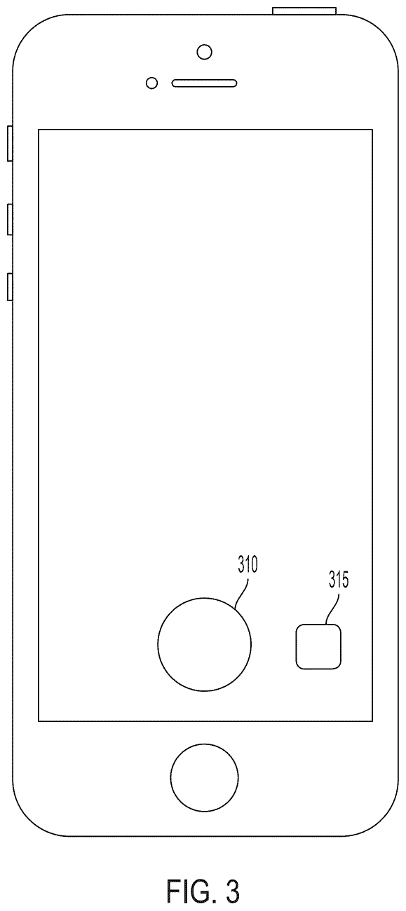

FIG. 3 depicts an example user interface on a smartphone according to one or more embodiments described herein. In particular, FIG. 3 illustrates the video camera screen of the smartphone from which a user may record or import videos to be enhanced by ARE.

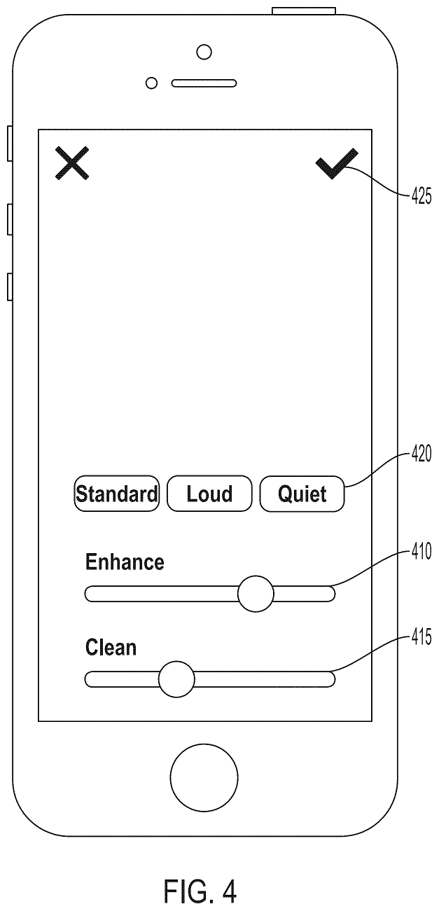

FIG. 4 depicts an example user interface on a smartphone according to one or more embodiments described herein. In particular, FIG. 4 illustrates a video preview screen in which a user edits the recorded video and then shares and/or saves the enhanced video.

### Stage 1: Recognition

FIG. 3 shows an example video camera screen from which a user may record or import videos to be enhanced by ARE. In some embodiments, the user may begin recording a video by engaging, selecting, or tapping the record button 310. Alternatively, the user may import one or more previously recorded videos using an import function by engaging, selecting, or tapping import button 315.

The recorded video may include an audio portion (e.g., audio portion data, audio stream, audio stream data, or recorded audio), a video portion (e.g., video portion data, video stream, or video stream data), or a combination thereof. In some embodiments, the audio portion of the recorded video may be enhanced using one or more computer-based techniques discussed herein. In some embodiments, the computer-based techniques discussed herein may be applied to an audio recording (e.g., a recorded audio, a recorded audio stream, or a recorded audio stream data) that is not part of a recorded video. In some embodiments, the recorded audio, whether part of a recorded video or not part of a recorded video, may be recorded using or captured by one or more microphones of a smartphone, tablet, laptop, concert sound system, stage sound system, broadcast system (e.g., adapted for use at a live event), field reporting system (e.g., adapted for use at a live event), microphone array (e.g., a live-event microphone array), or the like.

FIGS. 1A-1C shows an example progression of the four stages of ARE as the user obtains an enhanced video using, for example, an app on the user's device (e.g., smartphone). In step 10, ARE may begin when the user engages the record button to begin recording a video. To optimize performance, audio may be recorded using an array of microphones within the recording device or individual microphones within the recording device. Audio may be recorded in stereo or mono, with the former maximizing search space and the latter maximizing speed as it pertains to the computer-implemented algorithms of stages 1-4. In some embodiments, audio file formats may be lossless (e.g., PCM, WAV, FLAC, etc.) or lossy (e.g., MP3, M4A, etc.), with the former providing more audio data and the latter providing faster results in the computer-implemented algorithms of stages 1-4.

In some embodiments, a user interface of the user's device may include a camera screen with a user-selectable ARE icon to enable or disable ARE (e.g., a button or switch to turn ARE on/off). In some embodiments, the user interface with the camera screen and the user-selectable ARE icon may be part of the native camera app of the user's device or may be part of another app of the user's device. For example, the user may use this button to quickly switch between recording normal video and recording enhanced video. This may be accomplished automatically by using, for example, audio fingerprinting and/or music detection algorithms such as spectral-feature analysis, onset or beat/tempo detection, energy or music-activity-based heuristics, machine-learned audio classification models (e.g., convolutional neural networks trained to distinguish music from non-music), or the like.

For example, if audio fingerprinting detects a matching media file while the user is recording video, ARE is executed. If not, video is recorded normally. Alternatively, the user may choose to process the recorded video with ARE once the recorded video is captured and saved.

In some embodiments, as opposed to recording videos, a user may import previously recorded videos. As an example, the user may select button 315 in FIG. 3 to import a previously recorded video.

In some embodiments, ARE may enhance any type of reference media. As an example, the reference media may be a song, a sound bite, a sample, an audio track or a snippet of an audio track, or a combination thereof. As an example, the reference media may be one or more of a movie, a film, a television show, a concert, a show, a broadcast, a sporting event, a speech, a news presentation, a podcast, a radio show, a sound effect, a live stream, or the like.

Referring to FIGS. 1A-1C, the recorded audio from the recorded video, referred to as query audio 15, may be immediately sent to the first stage, recognition 20. In the first stage, recognition 20, audio fingerprinting may be used to recognize the recorded media. In some embodiments, an audio fingerprint may be, for example, a condensed digital summary of the most noise-resistant points in an audio file. In some embodiments, to minimize computation time, ARE may execute both the video recording 10 thread and stage 1 recognition 20 thread in parallel.

In step 25, stage 1 may extract audio fingerprints from query audio 15. In some embodiments, audio fingerprints may be extracted from query audio 15 using a transform (e.g., a Fourier transform) as salient, robust acoustic features. In some embodiments, these acoustic features may be converted into a fingerprint representation for comparison against reference audio fingerprints 40. The features used in audio fingerprints may include noise resistant audio features, such as, spectral peaks. In step 30, the extracted fingerprints of query audio 15 may be passed to fingerprint matching 45.

In step 45, audio fingerprint matching may be performed. In some embodiments, extracted audio fingerprints 30 may be matched against the reference audio fingerprints of reference media 40. Reference audio fingerprints may be pre-extracted in advance and stored in reference audio fingerprint database 35 to increase the speed of the audio fingerprinting process. In some embodiments, audio fingerprints may be extracted from the reference media using a transform (e.g., Fourier transform) as salient, robust acoustic features. In some embodiments, the same transform may be used to extract the audio fingerprints from query audio 15 and from the reference media. In some embodiments, these acoustic features may be converted into a fingerprint representation for comparison against query audio fingerprints 30.

In some embodiments, for live events like concerts, the audio feed from the event may be live fingerprinted in real-time and added to fingerprint database 35. This reference audio may also be added to reference media database 60 for use in stages 2, 3 and 4 of ARE.

When the number of matching audio fingerprints between query audio fingerprints 30 and reference audio fingerprints 40 breaks a statistically significant threshold, audio fingerprint matching 45 may return a Media Identification (Media ID) with coarse temporal offset 50. The media ID may correspond to the song, movie, or other piece of media as identified by audio fingerprinting 20. The coarse temporal offset may be the time elapsed in the reference media when the reference media first appears (or is identified as first appearing) in the audio of the recorded video. As an example, if the reference media is a song, and if the user begins recording one minute into the song, the coarse temporal offset may be one minute.

In some embodiments, the coarse temporal offset may not be of sufficient temporal resolution to align the query audio and the reference media for cancellation and enhancement in stages 3 and 4. As an example, the resolution of temporal offsets returned by audio fingerprinting 20 may be defined by parameters such as, for example, the hop size. In some embodiments, the hop size may be the overlap ratio between consecutive short-time Fourier transform (STFT) frames. As an example, in audio fingerprinting hop sizes for song recognition, the resolution of temporal offsets may be on the order of centiseconds. However, this resolution may be too low for the cancellation and enhancement algorithms in stages 3 and 4, which require resolution on the order of milliseconds.

If the stage 1 audio fingerprinting hop size is reduced to yield higher-resolution temporal offsets, the computational complexity of audio fingerprinting may lead to unreasonably long computation times. To yield high-resolution offsets without increasing computation times to unreasonable levels, ARE may employ a coarse-to-fine search scheme. For example, ARE may use stage 1 20 to identify the media ID and coarse temporal offset 50, then may refine that offset in stage 2 synchronization by analyzing the reduced search space.

In some embodiments, the matching process for stage 1 audio fingerprinting 20 may be further optimized. Audio fingerprinting matching may use a statistical threshold based on the number of matching peaks. When this threshold is broken, a match may be declared. For song recognition using audio fingerprinting, this threshold may lead to false positive offsets due to similar sections of the media. For example, in a song with repeated choruses, a query from the first chorus may be very similar to a query from the second chorus. However, when this chorus ends, the song may diverge into different content. As a result, if the matching threshold of the fingerprinting algorithm is too low, false positive offsets may occur, which may lead to unacceptable results for cancellation and enhancement in stages 3 and 4. In some embodiments, audio fingerprint matching 45 may be optimized by increasing the matching threshold and/or tracking secondary results with high matching scores. In the latter case, if two or more potential offsets are close in the number of matching fingerprints, instead of relying on a threshold, fingerprint matching 45 may wait until there is an offset with a statistically significant lead in the number of fingerprint matches before declaring a match.

In some embodiments, audio fingerprinting may include landmark audio fingerprinting using spectral peaks to recognize background media. A time-frequency point may be defined as a spectral peak if it has a higher energy content than all surrounding peaks within a defined range. The highest energy points will survive factors like noise, distortion, and reverberation. Amplitude information of the spectral peaks may be discarded to produce sparse peak maps, which are more robust to gain changes and transient noise. Time-frequency points may be paired as “landmarks,” each encoding a pair of spectral peaks and their relative time offset, to increase entropy and improve collision resistance during hash table lookups. Exemplary landmark audio fingerprinting is discussed in, for example, A. Wang, “An Industrial Strength Audio Search Algorithm,” Proceedings of 4th International Conference on Music Information Retrieval, Baltimore, Maryland, Oct. 27-30, 2003 and U.S. Patent Application Publication No. 2002/0083060 to Wang et al.

In some embodiments, audio fingerprinting may include Philips Robust Hashing. Exemplary audio fingerprinting using Philips Robust Hashing is discussed in, for example, J. Haitsma et al., “A Highly Robust Audio Fingerprinting System,” Proceedings of 3rd International Conference on Music Information Retrieval, Paris, France, Oct. 13-17, 2002.

In addition to and/or instead of audio fingerprinting including landmark audio fingerprinting or Philips Robust Hashing, audio fingerprinting in stage 1 may include other types of audio signal processing as would be understood by one of ordinary skill in the art.

Returning to the user experience in the top row of FIG. 1, after stage 1 is complete, the user may still be recording video in step 55.

In some embodiments, the audio fingerprinting in stage 1 may begin either when the user begins recording video or before the user begins recording video. For example, stage 1 audio fingerprinting may begin when the user opens the app or navigates to the camera screen. As a result, stage 1 audio fingerprinting may provide faster and more accurate matches based on a larger sample size of recorded audio for fingerprinting. If a match has not been found when the user finishes recording the video, stage 1 and/or stage 2 may continue to analyze audio after the end of the video.

### Stage 2: Synchronization

In stage 2 synchronization, the audio in recorded video 15 may be synchronized with reference media 50 identified in stage 1 recognition 20. To increase the resolution of coarse temporal offset 50 returned by stage 1, ARE may employ a coarse-to-fine search scheme. First, stage 1 quickly recognizes the reference media and coarse temporal offset 50. Then stage 2 searches within identified reference media 50 to find fine-grained temporal offset 95 in a reduced search space. Because the search space has been reduced from millions of media to single identified media 50 in stage 1, stage 2 may employ more computationally complex audio fingerprinting parameters to yield high-resolution offsets for cancellation and enhancement algorithms in stages 3 and 4.

Signal synchronization approaches, like cross correlation, may fail in synchronizing a recorded video with a reference media when the recorded video has moderate-to-high noise or reverberation, both of which are often present in recorded video of events, such as an outdoor music festival or a house party. As such, in some embodiments, a more robust approach to stage 2 synchronization uses audio fingerprinting, which may be robust to both noise and reverberation without sacrificing speed.

In some embodiments, stage 2 audio fingerprinting may use fingerprinting methods and/or techniques known in the arts, for example, spectral peaks as used in landmark audio fingerprinting or energy band comparison as used in Philips Robust Hashing. In some embodiments, hyperparameters of the synchronization algorithm, such as hop size, window size, or frequency band selection, may be tuned to balance temporal resolution, computational complexity, and robustness to distortion.

In some embodiments, while landmark audio fingerprinting paired peaks may be used to increase entropy and speed up search, keeping peaks as single, unpaired points may lead to increased robustness with minimal effects on search speed due to the reduced search space of stage 2.

In some embodiments, a hashing method, such as Philips Robust Hashing, may be used as part of audio fingerprinting during synchronization in stage 2. Philips Robust Hashing is a type of audio fingerprinting that analyzes the frequency spectrum between 300 Hz and 2000 Hz, splitting the frequency spectrum into 33 bands as per the Bark scale. Each successive band may be analyzed for energy differences. The energy difference of successive bands, both in the temporal and spectral domains, may be defined as 0 or 1 based on whether the energy increases or decreases. This yields fingerprints that may be searched against reference fingerprints. Matches may be declared based on the result with the lowest bit error rate. For the purposes of stage 2, the hop size of Philips Robust Hashing may be reduced to yield fine-grained temporal offsets 95.

In some embodiments, any robust audio features that are resistant to noise and other signal degradations may be used to yield a fine-grained temporal offset 95 in stage 2. In some embodiments, cross correlation methods, such as, for example, generalized cross correlation, may be used to find the offset between the two audio signals.

In step 65, when the user begins recording video in step 10, stage 2 may extract fine-grained audio features from the query audio 15 to obtain fine-grained audio features 70. In some embodiments, fine-grained audio features may be extracted from query audio 15 using a transform (e.g., a Fourier transform) as high-resolution, robust acoustic features. In some embodiments, to speed up computation time, this processing thread may run parallel to other processing threads (e.g., video recording 10 and/or stage 1 20).

In some embodiments, stage 2 may begin after the full or partial completion of stage 1. Stage 2 may be executed serially or concurrently with stage 1, or may be executed in parallel with stage 1. For example, the determining of reference media data may be performed concurrently with the generating of synchronized media data. In some embodiments, the determining of reference media data and/or the generating of synchronized media data may be performed concurrently with the capture of media data (e.g., during audio capture of a live event, during audio recording).

The extracted fine-grained audio features of query 70 may be passed to fine-grained audio feature matching of step 75. In step 75, the extracted fine-grained audio features from query 70 may be compared with the extracted fine-grained audio features from reference media 90 that was recognized in stage 1.

While fine-grained audio feature extraction for the query audio in step 65 may begin as soon as the user begins recording video, fine-grained audio feature extraction for the reference media cannot begin until stage 1 has identified the reference media. Once stage 1 yields a reference media ID and coarse temporal offset 50, this information may be passed to reference media database 60. In the case of music, reference media database 60 may be a music database. Reference media database 60 may return the file of the identified media, which may be passed to stage 2 as a media clip with coarse alignment 80. In some embodiments, the identified media may be passed as an entire media file as opposed to a media clip.

In some embodiments, as opposed to sourcing the entire reference media file identified in step 50, coarse offset 50 from stage 1 may be used to source a shorter clip of the reference media file. For example, if coarse offset 50 was 13.78 seconds, the media clip would start at the coarse offset (13.78 seconds) minus the potential temporal error from audio fingerprinting. This media clip would extend to a duration equal to the query audio plus the maximum potential temporal error from audio fingerprinting. For example, if the query audio is 10.00 seconds long, the media clip would extend to 23.78 seconds into the identified media plus the maximum potential temporal error from audio fingerprinting. This range may be defined as [coarse_offset−max_offset_error: coarse_offset+query_length+max_offset_error]. If stage 1 finishes before the user finishes recording the video, the query_length in this formula will be undefined. In this case, the duration of the media clip may be the current length of the video clip or a predefined length that ensures there is enough search space for stage 2.

In step 85, fine-grained audio features may be extracted from the media clip with coarse alignment 80 to obtain fine-grained audio features 90. In some embodiments, fine-grained audio features are extracted from the media clip with coarse alignment 80 using a transform (e.g., a Fourier transform) as high-resolution, robust acoustic features. In some embodiments, the same transform may be used to extract the fine-grained audio features in step 65 and in step 85. In step 75, fine-grained audio features 90 may be matched with the extracted fine-grained audio features from query 70. In step 75, when a statistically significant confidence score or bit error threshold is exceeded, a fine-grained temporal offset may be declared 95, which may be used to create synchronized reference media clip 100. This media clip starts at the fine-grained temporal offset 95 and may be of a duration equal to the length of query audio 15. This media clip may be created by trimming the media clip with coarse alignment 80 using fine-grained temporal offset 95. Synchronized media clip 100 may be then passed to stages 3 and 4 for use in cancellation and enhancement.

In some embodiments, if fine-grained temporal offset 95 results of synchronization in step 75 are suboptimal in terms of robustness or accuracy, a two-step synchronization process may be employed to improve results. A first synchronization algorithm may be used to identify an initial offset. A second more fine-grained synchronization algorithm may then be applied, operating within a narrower search window informed by the initial offset from the first synchronization algorithm, and using dynamically adjusted, higher-resolution hyperparameters (including but not limited to hop size) to achieve a more robust and accurate fine-grained temporal offset 95.

In some embodiments, query audio 15 may be segmented into multiple independent sub-intervals prior to fine-grained audio feature extraction 65. Fine-grained temporal offset 95 may then be calculated separately for each sub-interval. This segmentation may improve synchronization accuracy or robustness in cases where portions of query audio 15 contain disruptive content, including but not limited to overlapping speech, shouting, or other non-media sounds that mask the recorded reference media in query audio 15. For example, if query audio 15 is 20 seconds in duration and contains crowd noise or vocal interruptions during the first 15 seconds, dividing the query into four 5-second sub-intervals may allow the last 5-second segment, containing cleaner reference media signal content, to achieve a statistically significant alignment with media clip 80, thereby improving the accuracy and/or robustness of the resulting fine-grained temporal offset 95. In some embodiments, a voting mechanism or heuristic may be used to select best fine-grained temporal offset candidate 95 from among fine-grained temporal offset results 95 of each sub-interval. This selection may be based on criteria including but not limited to identifying the segments that meet or exceed a threshold for bit error rate or confidence score, thereby ensuring only viable sub-intervals may be included in synchronization analysis. This may yield more robust and accurate fine-grained temporal offsets 95.

In some embodiments, stage 2 synchronization of reference media clip 80 and/or query audio 15 may be segmented into multiple overlapping chunks and processed in parallel using multithreading to improve synchronization performance and speed. In some embodiments, synchronization speed may be further accelerated by reducing the duration of query audio 15 and/or media clip 80.

In some embodiments, when stage 2 synchronization is unable to yield a bit error rate or confidence score that satisfies a predefined threshold in order to generate fine-grained temporal offset 95, the system may enter a corrective conditioning loop before re-running the synchronization process. In this loop, one or both of the input signals, namely, query audio 15 and media clip with coarse alignment 80, may be first routed through a signal-conditioning module that may restrict analysis to spectral regions most representative of the background media and/or least affected by non-media interference. The conditioning module may implement, for example, a parametrizable band-pass filter whose center frequency, bandwidth, slope, and/or order may be (i) preset, (ii) adaptively selected from statistics of previously attempted alignments, or (iii) progressively tightened on successive iterations. After each conditioning step, the system may re-execute fine-grained audio-feature extraction 65, 85 and matching 75 on input signals 15, 80, producing an updated set of candidate temporal offsets until at least one candidate may attain a statistically significant bit-error rate or confidence score that may satisfy the threshold, or until the conditioning loop may reach a maximum allowed number of iterations. Accordingly, the synchronization process may discover viable fine-grained temporal offset 95, even when the original query audio 15 may be severely contaminated by overlapping speech, crowd noise, loudspeaker distortion, or other adverse recording artifacts.

In some embodiments, as opposed to searching the entire media file identified in step 50, the search space for stage 2 may be narrowed using coarse temporal offset 50 found in stage 1. For example, if coarse offset 50 was 35.61 seconds, the search space for stage 2 could start at the coarse offset (35.61 seconds) minus the maximum potential temporal error from audio fingerprinting. This search space could extend to a duration equal to the query audio plus the maximum potential temporal error from audio fingerprinting. For example, if the query audio is 20 seconds long, the search space would extend to 55.61 seconds into the identified media plus the maximum potential temporal error from audio fingerprinting. This range may be defined as [coarse_offset−max_offset_error: coarse_offset+query_length+max_offset_error]. In doing so, the search space and resulting computation time may be reduced significantly. If stage 1 finishes before the user finishes recording the video, the query_length in this formula will be undefined. In this case, the duration of the search space may be the current length of the video clip or a predefined length that ensures there may be enough search space for stage 2.

### Optimized Extraction and Matching Using Stage 1 Results

In some embodiments, stage 2 may prioritize extraction in step 65 and step 85 and matching in step 75 for time-frequency regions that return audio feature results in steps 30, 40, and/or 45 in stage 1. For example, if stage 1 audio fingerprinting uses spectral peaks, time-frequency regions that contain matching peaks 45 in stage 1 may be hierarchized and/or weighted over time-frequency regions without matching peaks. As a result, stage 2 extraction 65, 85 and matching 75 may prioritize the time-frequency regions with the highest likelihood of being uncorrupted by factors like, for example, noise, distortion, or reverberation. For example, if stage 1 yielded a matching audio feature in step 45 at 12.32 seconds and 314 Hz in the reference media file, this time-frequency region (in both the query audio and reference media) may be weighted more heavily in stage 2 extraction 65, 85 and matching 75 than other time-frequency regions. This weighting may lead to improved robustness from fewer corrupted analysis frames and improved speed from a smaller search space. As such, stage 2 extraction 65, 85 and matching 75 may begin with the highest priority time-frequency regions then proceed in an ordered manner to lower-priority time-frequency regions if the matching threshold has not been reached.

In embodiments where stage 2 extraction of query audio 65 is executed parallel to stage 1 20, stage 2 may begin by extracting 65 and matching 75 the entire time-frequency range of query audio 15, and then stage 2 may begin to optimize the time-frequency range for extraction 65 and matching 75 of the query audio as stage 1 pulls ahead of stage 2 over time. So, initially stage 1 and stage 2 both start processing at the beginning of query audio 15. Because stage 1 may be less computationally complex than stage 2, stage 1 may execute extraction 25 and matching 45 of query audio 15 faster than stage 2 and pull ahead of stage 2 in progress. As stage 1 pulls ahead in progress as compared to stage 2, extraction 25 and matching 45 results that have been completed in stage 1 (but not yet processed in stage 2 due to its slower execution speed) may be used to optimize the time-frequency regions for extraction 65 and matching 75 in stage 2 for query audio 15. For example, if stage 1 yielded an audio feature in step 30 at 2.64 seconds and 837 Hz in the query audio, this time-frequency region in query audio 15 may be prioritized in stage 2 extraction 65 and matching 75 over other time-frequency regions of query audio 15. Once media ID 50 has been returned by stage 1, the time-frequency regions for fine-grained audio feature extraction of reference media 85 may be optimized using the same approach.

### Optimized Extraction and Matching Using Stage 2 Results

Extraction of the fine-grained audio features for the query audio in step 65 may begin before extraction of the fine-grained audio features for the reference media in step 85, the latter of which must wait until stage 1 returns media ID 50 in order to know what media file to analyze. In some embodiments, the results to that point in the extraction of fine-grained audio features for query audio 70 may be leveraged to improve extraction 85 and matching 75 of the fine-grained audio features for the reference media file based on the fact that the audio feature results in step 70 are the most relevant time-frequency regions for steps 85 and 75. For example, if there were a relevant fine-grained audio feature 70 for the query audio at 6.84 seconds and 1316 Hz (including but not limited to a spectral peak), this time-frequency region in the media clip with coarse alignment 80 based on alignment with query audio 15 using coarse temporal offset 50 could be hierarchized and/or weighted over other time-frequency regions without relevant audio features. As a result, fine-grained audio feature extraction 85 and matching 75 for the reference media file could prioritize the time-frequency regions with the highest likelihood of containing relevant audio features based on the results of query 70. This hierarchy and/or weighting may improve robustness and search speed. Because the alignment to this point may be based on the coarse temporal offset 50, the time range may be plus-minus the maximum temporal error of stage 1 audio fingerprinting 20.

### Pre-Extracted Fine-Grained Audio Features

In some embodiments, as opposed to extracting fine-grained audio features of reference media 85 on the fly, fine-grained audio features 90 for reference media database 60 may be pre-extracted and stored in a fine-grained audio feature database (not shown in FIGS. 1A-1C). In this technique, the pre-extracted fine-grained audio features from the reference media file may be instantly matched in step 75 against the extracted fine-grained audio features from query audio 70. Storing pre-extracted fine-grained audio features in a fine-grained audio feature database represents a major improvement in speed of stage 2 synchronization at the cost of storing a large database of dense audio features.

### Optimized Extraction and Matching Using Pre-Extracted Audio Features

In some embodiments, if fine-grained audio features of reference media 90 are pre-extracted and stored in a database (not shown in FIGS. 1A-1C), stage 2 may prioritize fine-grained audio feature extraction 65 and matching 75 for time-frequency regions of query audio 15 that correspond to relevant audio features in the pre-extracted fine-grained audio feature database of the reference media. For example, if there were a relevant audio feature in the pre-extracted fine-grained audio feature database at 6.53 seconds and 963 Hz of the reference media identified in step 50, this time-frequency region in query audio 15 based on alignment with the media clip with coarse alignment 80 using the coarse temporal offset 50 could be hierarchized and/or weighted over other time-frequency regions without relevant audio features. As a result, fine-grained audio feature extraction 65 and matching 75 could prioritize the time-frequency regions with the highest likelihood of containing relevant audio features. This hierarchy and/or weighting may lead to improved robustness and improved search speed. Because the alignment to this point may be based on coarse temporal offset 50, the time range may be plus-minus the maximum temporal error of stage 1 audio fingerprinting.

In some embodiments, as opposed to waiting for stage 2 fine-grained audio feature extraction 65, 85 to finish before beginning fine-grained audio feature matching 75, extraction and matching may run in parallel. If fine-grained audio feature matching 75 breaks a confidence score threshold, a result may be declared before fine-grained audio feature extraction 65, 85 may be complete.

In some embodiments, if stage 1 audio fingerprint matching 45 yields multiple candidate coarse temporal offsets 50 with high confidence scores, stage 2 may consider multiple candidate coarse temporal offsets in fine-grained audio feature extraction 65, 85 and matching 75. For example, media like songs may contain multiple choruses in which the audio is similar. If the video is recorded 10 during a section of the song in which a chorus occurs, there may be two or more candidate coarse temporal offsets 50 that yield high confidence scores in stage 1 audio fingerprint matching 45 due to the similarity of the repeated choruses. To increase the accuracy of fine-grained temporal offset 95 results, stage 2 may analyze multiple candidate coarse temporal offsets 50 from stage 1 as opposed to a single candidate coarse temporal offset. In some embodiments, stage 2 may analyze multiple candidate coarse temporal offsets 50 from stage 1 in parallel, thereby saving additional computational time.

Similarly, stage 1 may yield multiple candidate media ID's 50 with high audio fingerprint matching 45 scores. For example, a remixed version of a song and the original version of the song may produce similar extracted audio fingerprints 40 and as a result may yield similar audio fingerprint matching 45 results when compared to extracted audio fingerprints from the query audio 30. Stage 2 may consider multiple candidate reference media files 80, for example, if audio fingerprint matching 45 scores for more than one reference media break the confidence score threshold or if audio fingerprint matching 45 scores for the top performing reference media are within a statistically significant margin. In some embodiments, the user interface may present users with a choice of multiple candidate media files (each candidate media file associated with a different media ID), and the user may identify the correct media file.

In some embodiments, audio drift may occur between the query audio and the reference media. In the case of differing sample rates between the query audio and the reference media, correction may be obtained by resampling to a common sample rate. However, audio drift may also be caused by other acoustic factors. For example, the camera may change in position relative to the sound source over time as the user moves. In some embodiments, dynamic time warping may be used to correct for audio drift and maintain alignment of the query audio and the reference media over time. This drift correction may also be used to improve cancellation results in stage 3 and enhancement results in stage 4, for example, by modifying the reference media to fit the speed of the query audio.

In some embodiments, if hashing, such as Philips Robust Hashing, is used for synchronization in stage 2, and if the results of fine-grained audio feature matching in step 75 are suboptimal using the bands from the initial frequency range (for example, 300 to 2000 Hz), the bandwidth may be dynamically adjusted using different barks and/or frequency ranges (such as, for example, 2000 to 5000 Hz), and steps 65, 85, and 75 of the algorithm may be re-run to yield additional matching information.

In some embodiments, a machine learning solution may be trained on a large dataset of query audio 15 and media clips with coarse alignment 80 to improve performance of synchronization based on deeper latent features found by an artificial neural network. For example, a convolutional neural network or other suitable deep learning model including but not limited to a transformer-based architecture, recurrent neural network, or hybrid encoder-decoder model may be used to optimize, for example, (1) fine-grained audio feature extraction for both the query audio and reference media 65, 85 and (2) fine-grained audio feature matching 75 by identifying hierarchical max-pooled layers of features that are backpropagated to optimize for parameters that minimize error, thereby learning salient features for the audio signals that reduce dimensionality to yield improved robustness and speed of extraction 65, 85 and matching 75. The model may operate on time-frequency representations (e.g., spectrograms) and output alignment scores, matching indices, or learned embeddings for downstream use in synchronization. For example, robust hashing extracts 32 bands for each hop, yielding 6400 values per second. In some embodiments, discriminative features learned by a neural network trained on a large dataset of query audio 15 and media clips with coarse alignment 80 may compress the relevant values to yield faster execution and improved resistance to interferences like noise. In some embodiments, the media clips may be entire media files. In some embodiments, the model may be deployed on-device to accelerate synchronization in low-latency applications or in cloud-based pipelines for batch processing of video libraries.

A trained machine learning model may evaluate local or global characteristics of query audio 15 and/or reference media 80 to estimate a confidence score for each audio feature match or group of matches 75. In some embodiments, audio feature matches 75 with low estimated confidence may be excluded or down-weighted during the synchronization process to improve accuracy. In some embodiments, a neural network may preprocess audio input 15, 80 (e.g., spectrograms) prior to audio feature extraction 65, 85 to emphasize or enhance regions of input signal 15, 80 that may be more robust to noise, reverberation, or distortion. In some embodiments, a model may assist in selecting time-frequency points or spectral peaks that are more distinctive or reliable for audio feature extraction 65, 85, rather than relying solely on amplitude-based or threshold-based selection criteria. These enhancements may be applied in combination with existing synchronization methods to improve fine-grained temporal offset 95 detection, especially when synchronizing query audio 15 recorded in acoustically adverse environments.

In some embodiments, amplitude information may be stored with the extracted fine-grained audio features for query 70 and/or the extracted fine-grained audio features for reference media 90 for use in cancellation and/or enhancement in stages 3 and/or 4.

Returning to the user experience in the top row of FIG. 1B, in step 105, the user may finish recording video. In step 110, the user then may wait while processing is completed in stages 3 and 4. Depending on the length of the video, this wait time may be a few seconds to less than a second.

In some embodiments, the user may still be recording video during stage 3 and stage 4. For example, the user may still be recording video longer than 5-10 seconds. In this case, the partial audio that has been recorded to that point may be passed to stage 3 and stage 4 and processed as the user continues to record.

In some embodiments, some videos may have multiple correct fine-grained temporal offsets 95. For example, in a video with multiple speaker sources at different locations, the propagation time for the speaker that is farther from the microphone may be longer than the propagation time for the speaker that is closer. In this event, stage 2 may declare multiple matching fine-grained temporal offsets 95 and generate multiple synchronized media clips 100 to be used in stage 3 and stage 4.

### Stage 3: Cancellation

To this point, query audio 15 and synchronized media clip 100 may have been recognized in stage 1 and synchronized in stage 2. Query audio 15 and synchronized media clip 100 may be used as two inputs to stage 3, cancellation 115.

In some embodiments, a goal of stage 3 may be to attenuate the recorded media in query audio 15 without affecting non-media sounds such as voices, which represent desired ambient noise. The reason for attenuating the recorded media may be because the recorded media is of poor quality.

Stage 3 may assess how synchronized media clip 100 changes when played over speakers in the recording environment based on factors including, but not limited to, reverberation, movement of the microphone(s), or echo path changes in the recording environment (e.g., a door opening or closing). During stage 3, synchronized media clip 100 may be converted from the time domain to the frequency domain using a short-time Fourier transform (STFT) and provided to adaptive filter 120. Adaptive filter 120 may be applied to the STFT transformed media clip to create an initial estimate of how media clip 100 changes in the recording environment by modeling the acoustic transfer function (ATF) of query audio 15 recording environment to estimate reverberation, delay, and other environmental factors. In some embodiments, adaptive filter 120 may be realized with any suitable filter architecture including but not limited to finite-impulse-response (FIR), infinite-impulse-response (IIR), or functional equivalents thereof.

Query audio 15 may be converted from the time domain to the frequency domain using a short-time Fourier transform (STFT). The initial estimation from adaptive filter 120 may be subtracted from STFT transformed query audio 15. In some embodiments, the goal may be to find parameters of adaptive filter 120 that minimize the result of this subtraction equation.

Error signal 125 may be supplied to adaptive algorithm 130, which may compute a coefficient-update vector for adaptive filter 120. In some embodiments, adaptive algorithm 130 may update adaptive filter 120 coefficients using a technique selected from, but not limited to, least mean squares (LMS), recursive least squares (RLS), affine projection algorithms (APA), sub-band adaptive filtering, or functional equivalents thereof. These adaptive algorithms may be selected based on desired trade-offs between convergence speed, computational complexity, and robustness to signal variability.

Adaptive algorithm 130 may apply the coefficient updates to adaptive filter 120 to converge toward the impulse response that best cancels synchronized media clip 100 present in query audio 15. The upward arrow emanating from adaptive filter 120 may represent this coefficient-update path. Because each update may be driven by the instantaneous error, adaptive filter 120 may track time-varying echo paths and other acoustic changes in real time. In some embodiments, adaptive algorithm 130 may employ a variable step size to balance convergence speed and numerical stability. With each successive iteration of the error feedback loop, the coefficients of adaptive filter 120 may be refined to further reduce error 125 and enhance cancellation performance.

Adaptive filter 120 may converge to a minimum error, which signifies that the acoustics of the recording environment have been mapped. Even if the acoustics change due to factors like movement of the microphone or a door opening, adaptive algorithm 130 may detect such changes by monitoring the results of the subtraction equation and updating its coefficients.

In some embodiments, double-talk detector 135 may freeze the coefficients of adaptive filter 120 during periods of double-talk. As an example, double-talk may occur with the simultaneous presence of media and non-media background sounds (e.g., a person speaking over top of background music). Double-talk detector 135 may prevent adaptive filter 120 from erroneously adjusting its parameters and attenuating desired ambient sounds.

In some embodiments, both outputs of Stage 3, designated reference canceled audio 140 and rejected audio 145, may first be passed to an inverse short-time Fourier transform (ISTFT) to convert from the frequency domain back to the time domain. Reference canceled audio 140 may represent a version of query audio 15 with attenuated media sounds and preserved non-media sounds. In some embodiments, significant attenuation of media sounds may be achieved in reference canceled audio 140 using the techniques described herein. Rejected audio 145 may represent the audio removed by the in the process of cancellation 115 as per the formula rejected audio=query audio−reference canceled audio.

In some embodiments, instead of applying adaptive filter 120 to all bands, the adaptive filter may be applied to sub-bands (e.g., sub-band adaptive filtering). The numbers of sub-bands may be increased to improve performance at the cost of computational complexity.

In some embodiments, the double-talk detection may be implicit or optional, allowing adaptive filter 120 to continue updating its coefficients during periods of double-talk.

Adaptive filters may suffer from significant convergence error while adapting to the dynamic acoustics of a recording environment. Because ARE does not have a real time constraint (like adaptive filters in communications, such as telephony), stage 3 may employ a multi-iteration adaptive filter that significantly reduces convergence error by looping over itself multiple times and eliminating residual error with each iteration. In some embodiments, instead of iterating multiple times to reduce convergence error, a recursive least squares adaptive filter (RLS) may be used to achieve faster per-sample convergence by minimizing error over all past samples, or alternatively, adaptive filter 120 may be configured to converge at each sample through repeated internal updates before proceeding to the next input, thereby approximating a fully adapted state per sample.

In some embodiments, a combination of adaptive filter types may be used to optimize performance based on the specific requirements of sections within the signal. For example, in convergent sections of the signal, a recursive least squares adaptive filter or an affine projection adaptive filter may be used, and in divergent sections of the signal, a least mean squares adaptive filter may be used.

In some embodiments, nonlinear distortions caused by factors like loudspeakers may be canceled using nonlinear acoustic echo cancellation methods and/or techniques, such as, for example, Volterra series, Hammerstein models, or Wiener models.

In some embodiments, parts of the unwanted signal that were not canceled by adaptive filter 120 may be filtered using residual echo suppression methods and/or techniques, such as, for example, spectral subtraction or Wiener filters.

In some embodiments, a machine learning solution may improve results of cancellation 115 by training artificial neural networks on a large dataset of query audio 15 and synchronized media clips 100 to better recognize adaptive filter 120 characteristics. In some embodiments, the synchronized media clips 100 may be entire media files. In some embodiments, a neural network may be trained to optimize parameters and/or coefficients of adaptive filter 120 including but not limited to step size and consequently improve the performance of cancellation 115 in reference canceled audio 140 by better modeling the recorded reference media signal. In some embodiments, the neural network may output or initialize the coefficients of adaptive filter 120 or may generate a time-varying or frequency-dependent filter response based on the characteristics of query audio 15 and synchronized media clip 100. In some embodiments, the neural network may be designed to model a specific problem associated with ARE, such as, for example, nonlinear distortions from loudspeakers, echo path change, or double-talk. In some embodiments, the machine learning model may operate in the spectral domain to optimize frequency-selective attenuation across sub-bands. In some embodiments, adaptive filter 120 may serve as a layer within the neural network allowing the neural network parameters to be trained using joint optimization of the adaptive filter 120 and the neural network in a hybrid approach. In some embodiments, the model may be trained to minimize cancellation error, a perceptual loss, or a learned proxy for perceived media leakage in the output.

### Stage 4: Enhancement

### Enhancement Adaptive Filter

In some embodiments, query audio 15 may be enhanced using enhancement adaptive filtering 150. While adaptive filtering has traditionally been used for tasks such as echo cancellation or noise suppression, the inventors discovered that adaptive filtering may be used to improve the perceptual quality of query audio 15 by adaptively shaping it using synchronized media clip 100 as a reference.

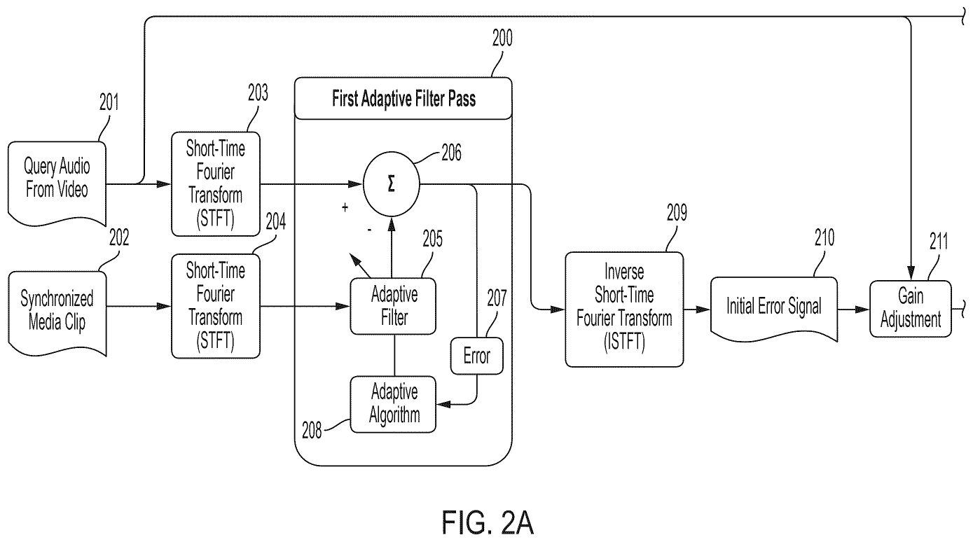

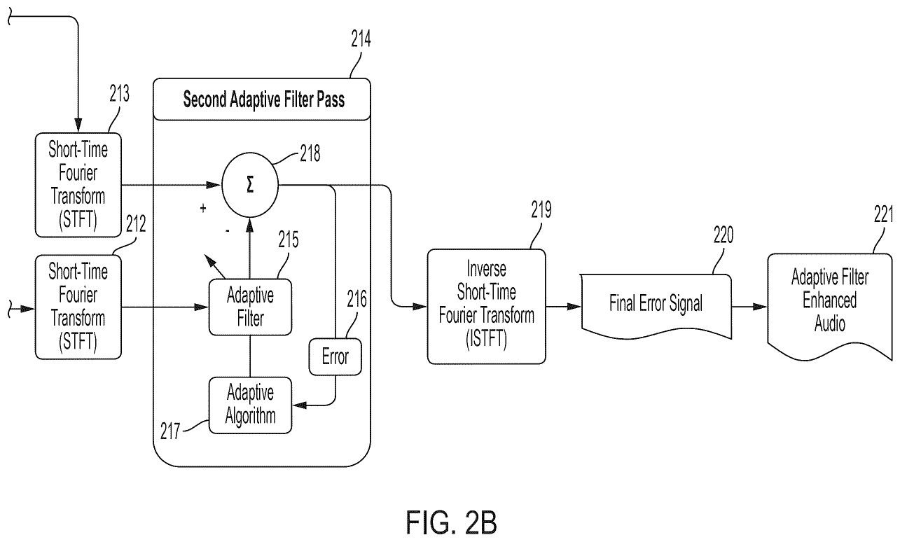

FIGS. 2A and 2B depict an example flowchart depicting a method for enhancing audio in a recorded video using an enhancement adaptive filter. In particular, FIGS. 2A and 2B illustrate the details of how enhancement adaptive filter 150 in FIG. 1C is used to enhance query audio 15 using synchronized media clip 100 as a reference.

In one embodiment, query audio 201 and synchronized media clip 202 may be respectively transformed from the time domain to the frequency domain using short-time Fourier transforms (STFTs) 203 and 204. The STFT of synchronized media clip 204 may be provided to adaptive filter 205, which generates an initial filtered output signal that may be subtracted from the STFT of query audio 203 at summation node 206. The difference between the STFT of query audio 203 and the filtered output of adaptive filter 205 may be computed at summation node 206, yielding intermediate error signal 207. Intermediate error signal 207 may be used to update the parameters of adaptive filter 205 via adaptive algorithm 208, which computes coefficient updates for adaptive filter 205. This feedback loop may enable adaptive filter 205 to iteratively update its coefficients to minimize error 207 in each sub-band, thereby generating an approximation of the acoustic characteristics of the recording environment of query audio 201.

In some embodiments, complete convergence of adaptive filter 205 toward zero error 207 steady-state may be neither expected nor desired. Both query audio 201 and synchronized media clip 202 may be highly non-stationary, containing time-varying musical passages, speech, crowd noise, and other transient events, and the acoustic path between the playback source and the recording microphone may change from moment to moment. These continual statistical shifts, together with microphone coloration, room-tone fluctuations, and other ambient interferences, may force adaptive filter 205 to readapt on every frame. Accordingly, the mean-square error may not be able to fully converge, and intermediate error signal 207 may persistently carry audio characteristics that adaptive filter 205 cannot model, including but not limited to reverb, microphone color, and room tone.

In some embodiments, upon completion of the feedback loop, the error from summation node 206 may be passed to inverse short-time Fourier transform (ISTFT) 209, which may reconstruct the time-domain signal known as initial error signal 210. The enhancement signal may be better preserved in initial error signal 210 itself (as opposed to the filtered signal output by adaptive filter 205), which retains the acoustic characteristics and ambient noises of query audio 201 that adaptive filter 205 could not model while simultaneously improving the perceptual quality of the background media present in query audio 201. Initial error signal 210 may represent a progressively refined transformation of query audio 201 produced by first adaptive filter pass 200. First adaptive filter pass 200 may enhance query audio 201 by adaptively reconstructing the spectral components of the recorded background media signal (corresponding to the reference media clip 202) that may be absent, masked, or degraded in query audio 201 due to real-world recording conditions, including but not limited to frequency loss or distortion, while simultaneously preserving desired real-world sounds and effects in query audio 201 such as voices, crowd noise, and reverb. Initial error signal 210 may be summarized as the difference between the STFT of query audio 203 and the filtered media clip that is output by adaptive filter 205, which may be represented by the simplified formula: initial error signal=query audio−filtered media clip.

In some embodiments, the process of enhancing the audio through enhancement adaptive filtering 150 may become more effective if the adaptive filter is run twice. In some embodiments, this may be implemented using first adaptive filter pass 200 as described above, followed by second adaptive filter pass 214 with the STFT of initial error signal 212 serving as the input to second adaptive filter 215 and the STFT of query audio 213 serving as a target for second adaptive filter 215.

In some embodiments, second adaptive filter pass 214 may begin by passing initial error signal 210 and query audio 201 to gain adjustment 211 step. Gain adjustment 211 may modify the amplitude of initial error signal 210 before it is passed as the input to second adaptive filter pass 214. The purpose of gain adjustment 211 may be to control the relative influence of initial error signal 210 versus query audio 201 during second adaptive filter pass 214 by modulating the amplitude of initial error signal 210. By increasing the amplitude of initial error signal 210 before second adaptive filter pass 214, adaptive filter 215 may be driven to favor initial error signal 210 more strongly (e.g., adapt less to query audio 201), whereas decreasing the amplitude of initial error signal 210 may allow adaptive filter 215 to remain more responsive to characteristics of query audio 201. In some embodiments, the gain adjustment may be performed using a loudness ratio computed from the root mean square (RMS) energy of synchronized media clip 202 and initial error signal 210, optionally modulated by a tunable parameter to set the desired balance.

After gain adjustment 211, initial error signal 210 may be passed to short-time Fourier transform (STFT) 212 to convert the signal from the time domain to the frequency domain. In parallel, query audio 201 may be passed to short-time Fourier transform (STFT) 213 to convert the signal from the time domain to the frequency domain. The STFT of initial error signal 212 may be provided to adaptive filter 215 of second adaptive filter pass 214, which may generate a filtered output signal that is subtracted from the STFT of query audio 213 at summation node 218, yielding intermediate error signal 216. Intermediate error signal 216 may be used to update the parameters of adaptive filter 215 via adaptive algorithm 217, which computes coefficient updates for adaptive filter 215. This feedback loop may enable adaptive filter 215 to iteratively update its coefficients to minimize error 216 in each sub-band, thereby generating an approximation of the acoustic characteristics of the recording environment of query audio 201. As mentioned in first adaptive filter pass 200, complete convergence of adaptive filter 215 to zero error 216 may be neither expected nor desired due to the non-stationary nature of query audio 201 and initial error signal 210. Accordingly, the mean-square error may not be able to fully converge, and intermediate error signal 216 may persistently carry audio characteristics that adaptive filter 215 cannot model, including but not limited to reverb, microphone color, and room tone.

In some embodiments, upon completion of the feedback loop, the error from summation node 218 may be passed to inverse short-time Fourier transform (ISTFT) 219, which may reconstruct the time-domain signal known as final error signal 220. As described in first adaptive filter pass 200, the enhancement signal may be better preserved in final error signal 220 itself (as opposed to the filtered signal output by adaptive filter 215), which may contain natural acoustics characteristics and ambient noises of the recording environment that adaptive filter 215 could not model. As described with first adaptive filter pass 200, second adaptive filter pass 214 may further enhance initial error signal 210 by adaptively reconstructing spectral components of the recorded background media signal (corresponding to reference media clip 202) that may be absent, masked, or degraded due to real-world recording conditions, while simultaneously preserving desired real-world sounds and effects such as voices, crowd noise, and reverb.

Final error signal 220 may be summarized as the difference between the STFT of query audio 213 and the filtered initial error signal that is output by adaptive filter 215, which may be represented by the simplified formula: final error signal=query audio-filtered initial error signal. Final error signal 220 may be designated as adaptive filter enhanced audio 221, which may represent the final output of enhancement adaptive filter 150.

In some embodiments, additional adaptive filter passes may also be employed to further improve the enhancement results of adaptive filter enhanced audio 221. In some embodiments, adaptive algorithms 208, 217 may update adaptive filter 205, 215 coefficients using a technique selected from, but not limited to, least mean squares (LMS), recursive least squares (RLS), affine projection algorithms (APA), sub-band adaptive filtering, or functional equivalents thereof. These adaptive algorithms may be selected based on desired trade-offs between convergence speed, computational complexity, and robustness to signal variability. The adaptive filtering algorithm may operate in real time or on previously recorded audio, enabling both streaming and batch enhancement modes.

In the case of poor-quality query audio 201, adaptive filter enhancement may inadvertently learn and preserve undesirable artifacts such as distortion, clipping, or excessive noise present in the original recording. To prevent this, the parameters of enhancement adaptive filter 150 may be constrained by minimum and/or maximum thresholds, or shaped using regularization techniques, to avoid excessive emphasis of degraded characteristics. These constraints ensure that adaptive filter enhanced audio 221 may emphasize fidelity and intelligibility without reinforcing the negative aspects of the recorded environment of query audio 201.

In some embodiments, enhancement adaptive filter 150 may run on the client-side (frontend) of a mobile, desktop, or web app to allow low-latency control via the user interface. In other embodiments, enhancement adaptive filter 150 processing may occur on a server-side (backend) system to leverage additional computing power.

Enhancement adaptive filtering 150 represents an application of adaptive signal processing for enhancing the perceived quality of background media in user-generated videos, delivering intelligible and immersive adaptive filter enhanced audio 221 by transforming original query audio 201 itself, without requiring playback or reproduction of synchronized media clip 202. By leveraging synchronized media clip 202 only as a reference guide signal rather than as part of final error signal 220, adaptive filter enhanced audio 221 may be treated as a transformation of a user's own query audio 201 rather than a reproduction or substitution of external media sources, like media clip 202.

### Room Acoustic Simulation

In some embodiments, room acoustic simulator 155 may use techniques such as acoustic simulation or auralization to simulate the acoustics of a recording environment of query audio 15, including but not limited to reverb, directionality, spatialization, frequency response, dynamic range control, and volume, in order to achieve a more realistic sounding enhancement effect. Because ARE does not know the acoustic characteristics of the recording environment in advance, room acoustic simulator 155 may use a sub-set of auralization known as blind auralization. Blind auralization may use the impulse response from real world recordings, like query audio 15, to create simulated acoustic parameters on the fly. Room acoustic simulator 155 may be convolved with the output of enhancement adaptive filter 150 (adaptive filter enhanced audio 221), applying the aforementioned auralization techniques to match the acoustic characteristics of query audio's 15 recording environment and create the output of stage 4, designated as reference enhanced audio 165.

In some embodiments, reference enhanced audio 165 may be derived directly from adaptive filter enhanced audio 221, omitting room acoustic simulator 155. In other embodiments, enhancement adaptive filtering 150 may be omitted, and synchronized media clip 100 may be processed solely by room acoustic simulator 155 to yield reference enhanced audio 165. In further embodiments, synchronized media clip 100 may be passed directly as reference enhanced audio 165 without enhancement adaptive filtering 150 or room acoustic simulation 155. For any of the enhancement pathways mentioned, the resulting audio may serve as the output of stage 4 and be passed as final reference enhanced audio 165.

Room acoustic simulator 155 may take an input of measured impulse response 160 to inform its parameters. Parameters of room acoustic simulator 155 may include but are not limited to reverberation time (T60), direct-to-reverberant ratio (DRR), echo density, spectral centroid, central time, and/or clarity.

In the case of poor-quality query audio 15, an exact simulation of acoustic characteristics may lead to overly realistic enhancements that sound too much like the negative aspects of the original recording. To prevent this, the parameters of room acoustic simulator 155 may be bounded by minimum and/or maximum thresholds to prevent extremes.

In addition to matching acoustic characteristics like reverb, room acoustic simulator 155 may also match dynamic changes in the recording such as volume and directionality. For example, if a user records a video in which the user moves closer to the speaker source during the video, the volume of the music will become louder as the user moves toward the speaker source. If a user turns down the volume on the speakers during the video, the volume of the music will decrease. If the user walks by a speaker on their left versus a speaker on their right, the directionality of the sound changes. Simulating these acoustic characteristics in stage 4 adds important realism to the final video.

In some embodiments, room acoustic simulator 155 may include simpler solutions including but not limited to algorithmic or convolution reverb that simulates a recording environment based on presets such as a small room or an outdoor space. This reverb may be time-variant to match the dynamic nature of the recording environment's acoustic characteristics.

### Machine Learning-Based Audio Enhancement and Generation

In some embodiments, a machine learning solution may improve the results of Stage 4 enhancement by training artificial neural networks on a large dataset of query audio 15 and synchronized media clips 100 to better model acoustic transformations and enhance perceptual quality. These learned features may include, but are not limited to, reverberation patterns (e.g., long decay tails in large halls), spatial directionality (e.g., sound arriving more strongly in one channel, or shifting as the user moves the device), time-varying volume (e.g., a subject walking away from the sound source), frequency-dependent attenuation (e.g., loss of certain frequency ranges due to the limited frequency response of smartphone microphones), nonlinear distortion (e.g., clipping from speaker overload), off-axis coloration (e.g., dull or filtered sound when the mic is not aimed at the source), phase incoherence (e.g., destructive interference caused by sound reflecting off nearby surfaces and reaching the microphone at slightly different times), background noise masking (e.g., crowd noise masking desired sounds), impulse reflections (e.g., slapback echo off nearby surfaces), low-end loss (e.g., missing bass in phone recordings), high-end smearing (e.g., blurred transients in cymbals or consonants), spectral imbalance (e.g., overemphasized midrange due to occlusion), and microphone diaphragm overload (e.g., distortion from sudden loud bursts such as cheering).

In some embodiments, the machine learning model may operate independently or be integrated with other enhancement techniques, such as enhancement adaptive filtering 150 or room acoustic simulation 155, to adjust parameters dynamically or apply context-aware transformations. In certain embodiments, the model may also synthesize reference enhanced audio 165 content based on input features, predicted acoustic conditions, or learned media patterns, effectively generating new or augmented audio data to supplement or replace portions of the original recording. The neural network may be trained on pre-collected or synthetic datasets or updated over time using data obtained through user interaction with the system.

In some embodiments, the machine learning solution used in stage 4 for enhancement or audio generation of reference enhanced audio 165 may be implemented using various model architectures, including but not limited to convolutional neural networks (CNNs), recurrent neural networks (RNNs), long short-term memory (LSTM) networks, or encoder-decoder architectures such as UNet. These models may operate on time-domain audio, frequency-domain representations (e.g., spectrograms), or latent embeddings derived from audio data. In some embodiments, generative model architectures may be used to synthesize or regenerate audio content. Such models may include, but are not limited to, diffusion-based models that iteratively refine noisy inputs into coherent audio signals, autoregressive models that predict audio sample values sequentially, and transformer-based architectures trained to model temporal and spectral dependencies in audio data. In some embodiments, generative adversarial networks (GANs) may be used to enhance realism by discriminating between generated and true audio features during training. These models may be trained using supervised, unsupervised, or self-supervised learning paradigms depending on the availability and type of training data.

In some embodiments, stage 3 and stage 4 may be executed serially, concurrently, or in parallel. For example, the coefficients of adaptive filter 120 may be used to inform the parameters of room acoustic simulator 155 in stage 4 in parallel threads.

In some embodiments, enhancement may use the instrumental version of a song to better fit the desired effects. For example, if a subject in the video is singing karaoke, the instrumental version of the song may provide better enhancement effects by not drowning out the voice of the singer. If an instrumental is not available, the original version of the song may be converted into an instrumental using stem separation methods.

In some embodiments, other stems from the original song such as, for example, drums, bass, and/or guitar, may be removed using stem separation methods or the like to adjust the enhancement effect. In some embodiments, the user may remove one or more stems to adjust the enhancement effect via a user interface having one or more user-selectable icons (e.g., sliders, buttons, data fields) and/or other user interfaces.

In some embodiments, computer vision may be used to inform the stage 4 acoustic parameters of the recording environment for room acoustic simulator 155. For example, visual cues from the video may be analyzed using computer vision to ascertain the geometry of the room and generate a model to simulate acoustic characteristics.

In some embodiments, location data may be leveraged to improve the stage 4 acoustic parameters of the recording environment for room acoustic simulator 155. For example, a user may record at a concert venue in which the acoustic profile has been previously mapped from other videos. This information may be leveraged to improve the acoustic modeling of future videos at the same location.

### Video Preview Screen

In step 170, outputs of stage 3 (e.g., reference canceled audio 140 and rejected audio 145) and output of stage 4 (e.g., reference enhanced audio 165) may be passed to the user's device. In some embodiments, audio inputs may first be amplitude-normalized (e.g., to a common RMS or loudness target) to ensure uniform signal levels for subsequent processing. In step 170, the user may adjust levels of cancellation and/or enhancement to desired preferences on the video preview screen. In step 175, when finished adjusting enhancement effects, the user may share the video and/or save the video to their device or to another storage or memory. As an example, the user may share the video to a third party social media website or app (e.g., Instagram®, Facebook®, TikTok®). As an example, the user may save the video to non-removable memory or removable memory of their device. As an example, the user may save the video to a cloud storage device.

FIG. 4 illustrates an example video preview screen, which allows users to adjust enhancement and cancellation levels using a user interface having one or more user-selectable icons (e.g., sliders, buttons, data fields) and/or other user interfaces as known in the art of mobile, desktop, or web app design. The video preview screen may be initialized to play the query video (the original video recorded by the user) and its associated audio in a loop. The query audio may be split into two separate tracks, reference canceled audio 140 and rejected audio 145, both of which may be initialized at 100% volume. The user may interact with ‘Enhance’ slider 410 to adjust the amplitude of reference enhanced audio 165 passed from stage 4. For example, when enhance slider 410 is engaged to the left, the amplitude of reference enhanced audio 165 may be set to 0%. As the user engages enhance slider 410 by moving the dial to the right, the amplitude of reference enhanced audio 165 may be increased incrementally from 0% up to 100% at full engagement of the slider dial to the right. In some embodiments, when the user drags enhance slider 410 to the right, the amplitude of reference-canceled audio 140 (or if stage 3 is omitted, original query audio 15), may be raised simultaneously, but within a lower, bounded range than reference-enhanced audio 165. This proportional amplitude boost allows desirable background elements such as voices and crowd noise to remain audible even as reference-enhanced audio 165 amplitude increases.

Because query audio 15 and reference enhanced audio 165 may be aligned based on fine-grained temporal offset 95 from stage 2, when reference canceled audio 140 and reference enhanced audio 165 are additively mixed using enhance slider 410, the result may be constructive interference as the in-phase signals superpose to create a smooth enhancement effect. In some embodiments, stage 3 may be omitted, and only query audio 15 (in place of reference canceled audio 140 and rejected audio 145) and reference enhanced audio 165 may be passed to video preview screen 170. In such cases, query audio 15 and reference enhanced audio 165 may be additively mixed using enhance slider 410 as described above.

In some embodiments, enhance slider 410 may be directly tied to the internal behavior of enhancement adaptive filter 150 such that the filter's adaptive response dynamically adjusts in real time based on the position of enhance slider 410. Rather than computing a fixed, fully adapted adaptive filter enhanced output 221, enhancement adaptive filter 150 may instead modulate its adaption level based on the engagement of enhance slider 410. For example, at lower slider values, the parameters of enhancement adaptive filter 150 may be altered, including but not limited to reducing the step size or limiting the number of iterations, which may result in a less aggressive transformation of query audio 15. As enhance slider 410 is moved toward full engagement, enhancement adaptive filter 150 may increase its responsiveness and apply more pronounced signal shaping. In this way, the perceived enhancement effect may not only be a function of additive mixing but also of real-time modulation of the internal adaptation behavior of enhancement adaptive filter 150, which may yield finer control over the extent of enhancement applied to query audio 15 using enhance slider 410.

In other embodiments, as opposed to changing the parameters of enhancement adaptive filter 150 in real-time as enhance slider 410 is adjusted, the enhancement adaptive filter may generate a set of preprocessed adaptive filter enhanced signals, each representing a different degree of adaptation levels (for example, one signal at 25% adaptation, one at 50%, one at 75%, and one at 100%). These versions may correspond to varying numbers of adaptive filter iterations, step sizes, or other variations of the parameters of enhancement adaptive filter 150. At runtime, as the user engages enhance slider 410, the system may interpolate between these variable adaptive filter enhanced signals to produce a continuously adjustable output that may reflect the slider's position. Rather than modifying enhancement adaptive filter 150 in real time, this approach may allow the system to fade or crossfade between precomputed enhancement levels, ensuring smooth transitions and low-latency responsiveness. In this way, the perceived enhancement strength may be controlled through audio interpolation rather than dynamic filtering.

The user may interact with ‘Clean’ slider 415 to adjust the level of cancellation. This slider may use the two audio signals passed from stage 3, reference canceled audio 140 and rejected audio 145 (which may be the audio signal removed by the adaptive filter). When clean slider 415 is engaged fully to the left, the amplitude of both reference canceled audio 140 and rejected audio 145 may be set to 100%. As the user engages clean slider 415 by moving the slider dial to the right, the amplitude of rejected audio 145 may be incrementally lowered from 100% down to 0% at full engagement of the slider dial to the right. This creates a cancellation effect that cleans the audio signal by removing rejected audio 145 and leaving only reference canceled audio 140. In some embodiments, stage 3 may be omitted, and only query audio 15 (in place of reference canceled audio 140 and rejected audio 145) may be passed to video preview screen 170. In this configuration, query audio 15 may be attenuated down to a bounded minimum level (avoiding complete silence while still reducing unwanted content) using clean slider 415 as described above.

Upon choosing the desired enhancement levels the user may share or save the video to the user's device by selecting user-selectable icon 425. The three separate audio tracks (e.g., reference enhanced audio 165, reference canceled audio 140, and rejected audio 145) may be saved at their respective amplitude levels as defined by the user-inputted slider values and merged into one final video. For example, if enhance slider 410 was at 50% engagement, reference enhanced audio 165 would be saved at 50% amplitude. If clean slider 415 was at 25% engagement, rejected audio 145 would be saved at 75% amplitude, and reference canceled audio 140 would be saved at 100% amplitude.

In some embodiments, the user interface of the video preview screen may include only enhance slider 410 and/or preset buttons 420. In some embodiments, the effects of enhance slider 410 and clean slider 415 may be combined into a single slider. For example, the effects of both sliders may be combined by having the combined slider adjust the parameters for both reference enhanced audio 165 and rejected audio 145. When the combined slider is engaged fully to the left, the amplitude of reference enhanced audio 165 may be set to 0%, and the amplitude of rejected audio 145 may be set to 100%. As the user engages the slider by moving the dial to the right, the amplitude of reference enhanced audio 165 may be incrementally increased up to 100% at full engagement of the slider, and rejected audio 145 may be incrementally lowered down to 0% at full engagement of the slider.

In some embodiments, sliders 410 and 415 may be in multiple orientations, such as horizontal or vertical. In some embodiments, the sliders may also be in the form of buttons 420, which correspond to predefined specific levels of the aforementioned variables and other acoustic parameters. For example, a preset of ‘Loud’ may set enhance slider 410 to 75% and clean slider 415 to 25%, whereas a preset of “Quiet” may set enhance slider 410 to 25% and clean slider 415 to 10%.

In some embodiments, the video preview screen seen in FIG. 4 may also contain a user interface (such as buttons) to adjust other acoustic parameters of reference enhanced audio 165 including but not limited to reverb, directionality, spatialization, equalization, amplitude, pitch, etc. For example, preset buttons 420 may correspond to the acoustic profiles of a small room, a large room, a concert hall, outdoors, or the like. With the user interface, the user may create other effects that add to the entertainment value of the video, for example creating an enhancement effect that fades in and out at a chosen time.

In some embodiments, to automatically determine how and when reference enhanced audio 165 should fade in or fade out (for example, increasing the amplitude of reference enhanced audio 165 as the user walks closer to the music playback source), the amplitude of the matching audio features in step 45 and/or step 75 may be analyzed. For example, if there is a matching audio feature in step 75 between reference audio features 90 and query audio features 70 at 45 seconds with an amplitude of 4 dB, the amplitude of reference enhanced audio 165 at that time may be determined relative to the amplitudes of neighboring matching audio features. For example, if the amplitude of the successive matching audio feature in step 75 at 46 seconds was 6 dB, the amplitude of reference enhanced audio 165 may become proportionately louder in the time between these neighboring matching audio features at 45 seconds and 46 seconds. By analyzing only matching audio features, the amplitude of the recorded media in query audio 15 may be isolated relative to the amplitude of recorded non-media sounds in query audio 15. For example, query audio 15 may become louder based on increased amplitude of recorded non-media sounds like a user talking, but the recorded media may stay at the same amplitude.

In some embodiments, for query audio 15 in which the recorded media is high amplitude, cancellation in addition to the effects of stage 3 115 may be required. This additional cancellation may be accomplished by programming clean slider 415 to also lower the amplitude of reference canceled audio 140. In doing so, the user may decrease the amplitude of the recorded media in query audio 15 at the expense of other recorded non-media sounds like voices.

In some embodiments, the user interface of the video preview screen seen in FIG. 4 may incorporate direct sharing options for social media platforms including but not limited to TikTok®, Instagram®, and Facebook®.

In some embodiments, if ARE returns the wrong media file from Stage 1 in step 50, for example the wrong song, the user may manually input the correct media file to fix the cancellation and enhancement in stages 3 and 4.

In some embodiments, users often record videos featuring multiple clips recorded at different times that are stitched together as a single video as popularized by apps like Instagram® and TikTok®. For example, a user may record a 5 second video clip of a party, then record another 3 second video clip of the same party later in the night. For this type of video, if ARE were to use only one offset and/or media ID in stage 1 50 and stage 2 95, this may lead to poor sounding results as the second video clip does not share the same offset and/or media ID as the first clip. To fix this, ARE may detect multiple offsets from the same or different media to create multiple enhancement effects within a single video. The point at which the offset and/or media ID changes from one video clip to the next may be determined manually based on user input, for example when the user ends the first clip and begins recording the second clip on the camera screen of the user interface seen in FIG. 3.

In some embodiments, the point in time at which the offset and/or media ID changes between video clips may be determined automatically by monitoring the change in matching offsets of stage 1 45 and/or stage 2 75. For example, if the offset 13.324 seconds has a statistically significant majority of audio feature matches in the first 5 seconds of a video, then in the following 5 seconds of the same video the offset 34.528 seconds for the same or a different media overtakes the original offset as having the most matching audio features, the point in time at which the majority of matching audio features shifts from offset 1 to offset 2 may be declared as the point in time at which the new video clip begins. These multiple offsets may be used to source multiple synchronized media clips 100 for cancellation and enhancement.

In some embodiments, the recorded media in query audio 15 may change in a single continuous video as opposed to in a video with multiple clips. For example, while recording a single continuous video, a user may skip a song, or a background song may end and a new background song may begin playing. The point in time at which the media ID changes may be determined automatically by monitoring the change in matching audio feature offsets of stage 1 45 and/or stage 2 75. For example, if Song A has a statistically significant majority of matching audio features in the first 3 seconds of a video, then in the remainder of the video Song B overtakes Song A as having the most matching audio features, the point in time at which the majority of matching audio features shifts from Song A to Song B may be declared as the point in time at which the new song begins. These multiple offsets may be used to source multiple synchronized media clips 100 for cancellation and enhancement.

In some embodiments, query audio 15 may contain two pieces of media that overlap, for example when a DJ transitions between songs using a crossfade. As described in the previous paragraph, the point in time at which the media ID changes may be determined automatically by monitoring the change in matching audio feature offsets of stage 1 45 and/or stage 2 75. For example, if Song A has a statistically significant majority of matching audio features in the first 3 seconds of a video, then in the remainder of the video Song B overtakes Song A as having the most matching audio features, the point in time at which the majority of matching audio features shifts from Song A to Song B may be declared as the point in time at which the new song begins. In some embodiments, in the case of overlapping songs with a crossfade, it may be desired to replicate this overlap in cancellation and enhancement in stages 3 and 4. In some embodiments, if a statistically significant number of matching audio features in step 45 and/or step 75 exists before and/or after the point in time at which the majority of matching audio features shifts from Song A to Song B at, for example, 3 seconds, the relative amplitude of these matching audio features may be leveraged to inform a fade in and/or fade out effect corresponding to the overlapping crossfade of the two songs. For example, if there is a matching audio feature in step 75 between the reference audio features 90 and the query audio features 70 for Song B at 2.5 seconds with an amplitude of 1 dB, and there is another matching audio feature in step 75 between reference audio features 90 and query audio features 70 for Song B at 3 seconds with an amplitude of 4 dB, the amplitude of reference enhanced audio 165 for Song B may fade in starting at 2.5 seconds and become proportionately louder as it approaches 3 seconds. During this time, reference enhanced audio 165 for Song A may also begin to fade out based on a similar analysis of the amplitudes of neighboring matching audio features.

In some embodiments, the output of stage 3 140, 145 and/or stage 4 165 may be returned with partial results and improved over time as the user adjusts enhanced video in step 170. For example, reference canceled audio 140 may be passed with only a single iteration of adaptive filter 120. During the time that the user previews the enhanced video and edits enhancements in step 170, stage 3 may continue to iterate the adaptive filter to achieve better performance. The updated results from stage 3 and/or stage 4 may be passed in real time while the user previews the video in step 170. When the user chooses to save or share the video, the results may be finalized.

In some embodiments, a user's device may record a video of media playing over speakers controlled by another device, for example a radio or a television. In some embodiments, the user may select a media file using an app on their device before recording the video as popularized in the video creation process on apps like TikTok®. When the user begins recording a video 10, the selected media plays from their device as the user records the video on the device. For example, a user may choose a song by The Beatles before recording the video, and then when the user begins recording 10, the song plays over the device or external speakers connected to the device. For such a situation, ARE may then enhance query audio 15 using the same process as described herein. In some embodiments, stage 1 20 may be replaced by using the media ID based on the user's selection in the app.

In some embodiments, ARE may be optimized for the purposes of livestreaming as popularized by platforms like Twitch®. For such a situation, once stage 1 identifies the media ID 50 and stage 2 identifies fine-grained temporal offset 95, stage 3 cancellation and stage 4 enhancement may be streamed to keep up with the real-time requirements of livestreaming. Because more than one piece of media may be played within a single livestream (for example, a streamer listening to dozens of songs within an hour-long livestream), stage 1 may continuously look for changes in media. This continuous monitoring may be accomplished by monitoring the number of matching audio fingerprints in real time. When the number of matching audio fingerprints for a new piece of media breaks a statistically significant threshold, a new match may be declared and cancellation in stage 3 and enhancement in stage 4 may be adjusted. In some embodiments, a user may manually direct the algorithm to look for a new piece of media.

In some embodiments, while the smartphone is used to describe the computing device used herein, recording video and/or enhancing audio may be implemented using any computing device, including but not limited to one or more laptops, desktop computers, tablets, web cameras (e.g., with on-board computing), microphones (e.g., with on-board computing), non-mobile cameras (e.g., with on-board computing), smart glasses, virtual reality (VR) headsets, digital audio workstations, audio processing servers, live sound mixing consoles, broadcast audio processors, or the like.

In some embodiments, ARE may be deployed as an independent mobile, desktop, or web app or integrated within the camera software of existing mobile, desktop, or web apps such as social media platforms or video editing services. As opposed to deployment in a mobile, desktop, or web app, ARE may be integrated into the native camera software of smartphones or other computing devices.

In some embodiments, other reference media related to an event may be added to the enhanced video. For example, if a user records a video at a basketball game, additional synchronized media may be incorporated including but not limited to the commentary on the television broadcast or the sounds from the microphone on the basketball court. In addition to using stage 1 audio fingerprinting, this approach may also identify the media file using location and/or may identify the offset using system or network-based time data. For example, if a user was within a close distance of a concert or sporting event, ARE may identify that event based on the user's location, and/or may identify the offset based on the system or network-based time of when the recording was initiated. In some embodiments, a user may manually search for names of events within the user interface (for example, a concert or a sporting event), and the selected event may be used in the audio processing as described herein.

In some embodiments, audio enhancement controls such as sliders or buttons may be adjusted when viewing the videos on social media platforms. For example, a user watching a video on social media may want to see the before-and-after of enhancement. The social media app may present a user interface similar to the video preview screen, such as the example depicted in FIG. 4 that allows end-users to adjust enhancement effects while viewing videos. Videos from the preview screen may be saved with multiple associated audio tracks (e.g., reference enhanced audio 165, reference canceled audio 140, and rejected audio 145) that enable adjustment of the enhancement effects.

In some embodiments, a user may import the user's own media files to serve as the reference media files in ARE. For example, a user may import a remix of a song that is not contained in the media database.

In some embodiments, ARE may achieve acceptable enhancement effects without implementing stage 3 and/or stage 4. In this case, ARE would execute stage 1 and stage 2, then synchronized media clip 100 would be additively mixed with query audio 15 to yield the enhancement effect as described in video preview screen section 170.

### Exemplary Computer Apparatus

FIG. 5 depicts an example computer apparatus for use with the embodiments herein. As an example, apparatus 500 may be a computer to implement certain inventive techniques disclosed herein, such as a first computing device to implement the user experience (top row in FIGS. 1A-1C) and a second computing device to implement automatic reference enhancement (bottom row in FIGS. 1A-1C). As an example, the client device of the user performing the user experience (top row in FIGS. 1A-1C) may be implemented by first apparatus 500, and a server device performing automatic reference enhancement (bottom row in FIGS. 1A-1C) may be implemented by second apparatus 500. As an example, some or all of the steps in the method illustrated in FIGS. 1A-1C may be performed on single apparatus 500. As an example, the steps in the method illustrated in FIGS. 1A-1C may be performed by one, two, three, four, or more apparatuses 500. As an example, apparatus 500 of the user may be a smartphone or other portable computer device (e.g., a tablet or a laptop).

Apparatus 500 may include one or more processors 502, memory 503, one or more input devices 505, and one or more output devices 506. Apparatus 500 may include other devices, components, features, and the like of a computer or a computing device as would be understood by one of ordinary skill in the art.

Input to apparatus 500 may be provided by one or more input devices 505, provided from one or more input devices in communication with apparatus 500 via link 501 (e.g., a wired link or a wireless link), and/or provided from another computer(s) in communication with apparatus 500 via link 501.

Output for apparatus 500 may be provided by one or more output devices 506, provided to one or more output devices in communication with apparatus 500 via link 501, and/or provided from another computer(s) in communication with apparatus 500 via link 501. One or more output devices 506 may include one or more displays and one or more speakers. Output device(s) 506 may play audio and display video of recorded video and/or enhanced video according to one or more embodiments described herein.

In some embodiments, one or more input devices 505 and one or more output devices 506 may be combined into one or more unitary input/output devices (e.g., a touch screen on a smartphone).

In some embodiments, based on input from one or more input devices 505 or input from outside apparatus 500 via the link 501, one or more processors 502 may perform operations as described herein. As an example, user input may be received from one or more input devices 505. As an example, input may be from another computer in communication with apparatus 500 via link 501. As an example, input may be from one or more input devices in communication with apparatus 500 via link 501.

In some embodiments, one or more processors 502 may perform operations as described herein and provide results of the operations as output. As an example, output may be provided to one or more output devices 506. As an example, output may be provided to another computer in communication with apparatus 500 via link 501. As an example, output may be provided to one or more output devices in communication with apparatus 500 via link 501.

Memory 503 may be accessible by one or more processors 502 so that one or more processors 502 may read information from and write information to memory 503. Memory 503 may store instructions that, when executed by one or more processors 502, implement one or more embodiments described herein. Memory 503 may be a non-transitory computer readable medium (or a non-transitory processor readable medium) containing a set of instructions thereon for enhancing audio in a recorded video, wherein when executed by a processor (such as one or more processors 502), the instructions cause the processor to perform one or more methods discussed herein. As an example, apparatus 500 may be a smartphone, and memory of the smartphone may store an app to perform embodiments described herein.

Apparatus 500 may be an apparatus for enhancing audio in a recorded video, the apparatus including: one or more processors (such as one or more processors 502); and memory (such as memory 503) accessible by the one or more processors, the memory storing instructions that when executed by the one or more processors, cause the apparatus to perform one or more methods described herein.

Memory 503 may be a non-transitory processor readable medium containing a set of instructions thereon for enhancing audio in a recorded video, wherein when executed by a processor (such as processor 502), the instructions cause the processor to perform one or more methods described herein.

### Illustrated Embodiments

The invention includes other illustrative embodiments (“Embodiments”) as follows.

Embodiment 1. A computer-implemented method for enhancing audio, the method comprising: receiving audio portion data of a recorded video, the audio portion data comprising non-media sounds and media sounds; determining reference media data for the media sounds in the audio portion data of the recorded video; generating synchronized media data based at least on the reference media data and the media sounds in the audio portion data, the synchronized media data being synchronized to the media sounds in the audio portion data; providing, to a device, at least one of the synchronized media data or data based on the synchronized media data for combining the synchronized media data and the audio portion data to obtain an enhanced video.

Embodiment 2. The method of embodiment 1, wherein determining the reference media data comprises: extracting one or more audio fingerprints from the media sounds; and matching at least one of the one or more audio fingerprints against one or more reference audio fingerprints to identify the reference media data.

Embodiment 3. The method of embodiment 1, wherein generating the synchronized media data comprises: identifying a coarse temporal offset for the reference media data when compared to the audio portion data; identifying a fine-grained temporal offset for the reference media data when compared to the audio portion data, wherein the fine-grained temporal offset search space is based on at least one of the determined reference media data or the coarse temporal offset; and generating the synchronized media data based on the reference media data, the media sounds in the audio portion data, and the fine-grained temporal offset.

Embodiment 4. The method of embodiment 3, wherein identifying the fine-grained temporal offset comprises: segmenting the audio portion data into a plurality of independent sub-intervals; determining a separate fine-grained temporal offset for each of the plurality of independent sub-intervals; and selecting the fine-grained temporal offset from among the fine-grained temporal offsets of the plurality of independent sub-intervals using a voting mechanism or lowest bit-error criterion.

Embodiment 5. The method of embodiment 3, wherein identifying the fine-grained temporal offset comprises: segmenting the reference media data and the audio portion data into a plurality of overlapping segments; and processing the plurality of overlapping segments in parallel using multithreading to improve synchronization performance and speed.

Embodiment 6. The method of embodiment 3, wherein identifying the fine-grained temporal offset comprises matching fine-grained audio features extracted from the audio portion data to pre-extracted fine-grained audio features of the reference media data that have been stored in a feature database.

Embodiment 7. The method of embodiment 1, further comprising: generating reference canceled audio data based on the audio portion data of the recorded video and the synchronized media data; and providing the reference canceled audio data to the device for combining the reference canceled audio data and the audio portion data to obtain the enhanced video.

Embodiment 8. The method of embodiment 7, wherein generating the reference canceled audio data comprises: providing the synchronized media data as a reference signal to an adaptive filter configured to cancel the media components from the audio portion data; generating an error signal by subtracting the adaptive filter output from the audio portion data; iteratively updating the filter coefficients based on the error signal using an adaptive algorithm until convergence; and subtracting the filter output at the converged filter coefficients from the audio portion data to yield the reference canceled audio data.

Embodiment 9. The method of embodiment 7, wherein generating the reference canceled audio data is performed concurrently with video recording.

Embodiment 10. The method of embodiment 1, further comprising: generating reference enhanced audio data based on the audio portion data and the synchronized media data; and providing the reference enhanced audio data to the device for combining the reference enhanced audio data and the audio portion data to obtain the enhanced video.

Embodiment 11. The method of embodiment 10, wherein generating the reference enhanced audio data comprises one or more of: providing the synchronized media data as a reference signal to an adaptive filter configured to enhance the media components of the audio portion data, generating an error signal by subtracting the filter output from the audio portion data, iteratively updating the filter coefficients based on the error signal using an adaptive algorithm, and using the final error signal as the reference enhanced audio data; applying one or more room acoustic simulation methods to model the recording environment's acoustics and generate the reference enhanced audio data; or passing the synchronized media data directly as the reference enhanced audio data without further modification.

Embodiment 12. The method of embodiment 10, wherein generating the reference enhanced audio data is performed concurrently with video recording.

Embodiment 13. The method of embodiment 1, wherein the synchronized media data is synchronized to the media sounds in the audio portion data.

Embodiment 14. The method of embodiment 1, wherein the audio portion data is captured by one or more microphones of a smartphone, tablet, laptop, concert sound system, stage sound system, broadcast system, field reporting system, or microphone array.

Embodiment 15. The method of embodiment 1, wherein determining the reference media data and generating the synchronized media data are performed concurrently.

Embodiment 16. The method of embodiment 1, wherein one or more of determining the reference media data or generating the synchronized media data is performed concurrently with video recording.

Embodiment 17. A non-transitory processor readable medium containing a set of instructions thereon for enhancing audio, wherein when executed by a processor, the instructions cause the processor to perform the method of embodiment 1.

Embodiment 18. An apparatus for enhancing audio, the apparatus comprising: one or more processors; and memory accessible by the one or more processors, the memory storing instructions that when executed by the one or more processors, cause the apparatus to perform the method of embodiment 1.

Embodiment 19. A computer-implemented method for enhancing audio, the method comprising: receiving audio stream data, the audio stream data comprising non-media sounds and media sounds; determining reference media data for the media sounds in the audio stream data; generating synchronized media data based at least on the reference media data and the media sounds in the audio stream data; and providing, to a device, at least one of the synchronized media data or data based on the synchronized media data to obtain an enhanced video.

Embodiment 20. The method of embodiment 19, wherein determining the reference media data comprises: extracting one or more audio fingerprints from the media sounds; and matching at least one of the one or more audio fingerprints against one or more reference audio fingerprints to identify the reference media data.

Embodiment 21. The method of embodiment 19, wherein generating the synchronized media data comprises: identifying a coarse temporal offset for the reference media data when compared to the audio stream data; identifying a fine-grained temporal offset for the reference media data when compared to the audio stream data, wherein the fine-grained temporal offset search space is based on at least one of the determined reference media data or the coarse temporal offset; and generating the synchronized media data based on the reference media data, the media sounds in the audio stream data, and the fine-grained temporal offset.

Embodiment 22. The method of embodiment 21, wherein identifying the fine-grained temporal offset comprises: segmenting the audio stream data into a plurality of independent sub-intervals; determining a separate fine-grained temporal offset for each of the plurality of independent sub-intervals; and selecting the fine-grained temporal offset from among the fine-grained temporal offsets of the plurality of independent sub-intervals using a voting mechanism or lowest bit-error criterion.

Embodiment 23. The method of embodiment 21, wherein identifying the fine-grained temporal offset comprises: segmenting the reference media data and the audio stream data into a plurality of overlapping segments; and processing the plurality of overlapping segments in parallel using multithreading to improve synchronization performance and speed.

Embodiment 24. The method of embodiment 21, wherein identifying the fine-grained temporal offset comprises matching fine-grained audio features extracted from the audio stream data to pre-extracted fine-grained audio features of the reference media data that have been stored in a feature database.

Embodiment 25. The method of embodiment 19, further comprising: generating reference canceled audio data based on the audio stream data and the synchronized media data; and providing the reference canceled audio data to the device for combining the reference canceled audio data and the audio stream data to obtain the enhanced video.

Embodiment 26. The method of embodiment 25, wherein generating the reference canceled audio data comprises: providing the synchronized media data as a reference signal to an adaptive filter configured to cancel the media components from the audio stream data; generating an error signal by subtracting the adaptive filter output from the audio stream data; iteratively updating the filter coefficients based on the error signal using an adaptive algorithm until convergence; and subtracting the filter output at the converged filter coefficients from the audio stream data to yield the reference canceled audio data.

Embodiment 27. The method of embodiment 25, wherein generating the reference canceled audio data is performed concurrently with audio capturing.

Embodiment 28. The method of embodiment 19, further comprising: generating reference enhanced audio data based on the audio stream data and the synchronized media data; and providing the reference enhanced audio data to the device for combining the reference enhanced audio data and the audio stream data to obtain the enhanced video.

Embodiment 29. The method of embodiment 28, wherein generating the reference enhanced audio data comprises one or more of: providing the synchronized media data as a reference signal to an adaptive filter configured to enhance the media components of the audio stream data, generating an error signal by subtracting the filter output from the audio stream data, iteratively updating the filter coefficients based on the error signal using an adaptive algorithm, and using the final error signal as the reference enhanced audio data; applying room acoustic simulation methods to model the recording environment's acoustics and generate the reference enhanced audio data; or passing the synchronized media data directly as the reference enhanced audio data without further modification.

Embodiment 30. The method of embodiment 28, wherein generating the reference enhanced audio data is performed concurrently with audio capturing.

Embodiment 31. The method of embodiment 19, wherein the synchronized media data is synchronized to the media sounds in the audio stream data.

Embodiment 32. The method of embodiment 19, wherein the audio stream data is captured by one or more microphones of a smartphone, tablet, laptop, concert sound system, stage sound system, broadcast system, field reporting system, or microphone array.

Embodiment 33. The method of embodiment 19, wherein determining the reference media data and generating the synchronized media data are performed concurrently.

Embodiment 34. The method of embodiment 19, wherein one or more of determining the reference media data or generating the synchronized media data is performed concurrently with audio capturing.

Embodiment 35. A non-transitory processor readable medium containing a set of instructions thereon for enhancing audio, wherein when executed by a processor, the instructions cause the processor to perform the method of embodiment 19.

Embodiment 36. An apparatus for enhancing audio, the apparatus comprising: one or more processors; and memory accessible by the one or more processors, the memory storing instructions that when executed by the one or more processors, cause the apparatus to perform the method of embodiment 19.

Embodiment 37. A computer-implemented method for enhancing audio, the method comprising: generating or obtaining a recorded video, the recorded video comprising audio portion data and video portion data, the audio portion data comprising non-media sounds and media sounds; receiving at least one of: reference canceled audio data, the reference canceled audio data based on the media sounds of the audio portion data and synchronized to the audio portion data of the recorded video; or reference enhanced audio data, the reference enhanced audio data based on the media sounds of the audio portion data and synchronized to the audio portion data of the recorded video; adjusting audio of the recorded video based on at least one of the reference canceled audio data or the reference enhanced audio data to obtain enhanced audio; and generating an enhanced video based on the recorded video and the enhanced audio.

Embodiment 38. The method of embodiment 37, further comprising: displaying a user-selectable icon to generate or obtain the recorded video, wherein generating or obtaining the recorded video is based on receiving a selection of the user-selectable icon.

Embodiment 39. The method of embodiment 37, further comprising: displaying, on the video recording screen, a user-selectable icon that enables a user to switch between generating a standard video and generating an enhanced video; and generating the video in the mode selected via the user-selectable icon.

Embodiment 40. The method of embodiment 37, further comprising: automatically selecting, during video generation, between generating a standard video and generating an enhanced video based on automatic content recognition of background media.

Embodiment 41. The method of embodiment 37, further comprising: displaying at least one user-selectable icon to adjust audio of the recorded video, wherein adjusting audio of the recorded video is based on receiving a selection of the at least one user-selectable icon.

Embodiment 42. The method of embodiment 37, further comprising: at least one of saving or sharing the enhanced video.

Embodiment 43. The method of embodiment 37, wherein the audio portion data of the recorded video was recorded by one or more microphones of a smartphone, tablet, or laptop, wherein the video portion data was recorded by a camera of the smartphone, tablet, or laptop.

Embodiment 44. A non-transitory processor readable medium containing a set of instructions thereon for enhancing audio, wherein when executed by a processor, the instructions cause the processor to perform the method of embodiment 37.

Embodiment 45. An apparatus for enhancing audio, the apparatus comprising: one or more processors; and memory accessible by the one or more processors, the memory storing instructions that when executed by the one or more processors, cause the apparatus to perform the method of embodiment 37.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

Numerous modifications, alterations, and changes to the described embodiments are possible without departing from the scope of the present invention defined in the claims. It is intended that the present invention need not be limited to the described embodiments, but that it has the full scope defined by the language of the following claims, and equivalents thereof.

What is claimed is:

1. A computer-implemented method for enhancing audio, the method comprising:
receiving audio portion data of a recorded video, the audio portion data comprising non-media sounds and media sounds;
determining reference media data for the media sounds in the audio portion data of the recorded video;
generating synchronized media data based at least on the reference media data and the media sounds in the audio portion data, the synchronized media data being synchronized to the media sounds in the audio portion data;
providing, to a device, at least one of the synchronized media data or data based on the synchronized media data for combining the synchronized media data and the audio portion data to obtain an enhanced video.

2. The method of claim 1, wherein determining the reference media data comprises:
extracting one or more audio fingerprints from the media sounds; and
matching at least one of the one or more audio fingerprints against one or more reference audio fingerprints to identify the reference media data.

3. The method of claim 1, wherein generating the synchronized media data comprises:
identifying a coarse temporal offset for the reference media data when compared to the audio portion data;
identifying a fine-grained temporal offset for the reference media data when compared to the audio portion data, wherein the fine-grained temporal offset search space is based on at least one of the determined reference media data or the coarse temporal offset; and
generating the synchronized media data based on the reference media data, the media sounds in the audio portion data, and the fine-grained temporal offset.

4. The method of claim 3, wherein identifying the fine-grained temporal offset comprises:
segmenting the audio portion data into a plurality of independent sub-intervals;
determining a separate fine-grained temporal offset for each of the plurality of independent sub-intervals; and
selecting the fine-grained temporal offset from among the fine-grained temporal offsets of the plurality of independent sub-intervals using a voting mechanism or lowest bit-error criterion.

5. The method of claim 3, wherein identifying the fine-grained temporal offset comprises:
segmenting the reference media data and the audio portion data into a plurality of overlapping segments; and
processing the plurality of overlapping segments in parallel using multithreading to improve synchronization performance and speed.

6. The method of claim 3, wherein identifying the fine-grained temporal offset comprises matching fine-grained audio features extracted from the audio portion data to pre-extracted fine-grained audio features of the reference media data that have been stored in a feature database.

7. The method of claim 1, further comprising:
generating reference canceled audio data based on the audio portion data of the recorded video and the synchronized media data; and
providing the reference canceled audio data to the device for combining the reference canceled audio data and the audio portion data to obtain the enhanced video.

8. The method of claim 7, wherein generating the reference canceled audio data comprises:
providing the synchronized media data as a reference signal to an adaptive filter configured to cancel the media components from the audio portion data;
generating an error signal by subtracting the adaptive filter output from the audio portion data;
iteratively updating the filter coefficients based on the error signal using an adaptive algorithm until convergence; and
subtracting the filter output at the converged filter coefficients from the audio portion data to yield the reference canceled audio data.

9. The method of claim 7, wherein generating the reference canceled audio data is performed concurrently with video recording.

10. The method of claim 1, further comprising:
generating reference enhanced audio data based on the audio portion data and the synchronized media data; and
providing the reference enhanced audio data to the device for combining the reference enhanced audio data and the original audio portion data to obtain the enhanced video.

11. The method of claim 10, wherein generating the reference enhanced audio data comprises one or more of:
providing the synchronized media data as a reference signal to an adaptive filter configured to enhance the media components of the audio portion data, generating an error signal by subtracting the filter output from the audio portion data, iteratively updating the filter coefficients based on the error signal using an adaptive algorithm, and using the final error signal as the reference enhanced audio data;
applying one or more room acoustic simulation methods to model the recording environment's acoustics and generate the reference enhanced audio data; or
passing the synchronized media data directly as the reference enhanced audio data without further modification.

12. The method of claim 10, wherein generating the reference enhanced audio data is performed concurrently with video recording.

13. The method of claim 1, wherein the synchronized media data is synchronized to the media sounds in the audio portion data.

14. The method of claim 1, wherein the audio portion data is captured by one or more microphones of a smartphone, tablet, laptop, concert sound system, stage sound system, broadcast system, field reporting system, or microphone array.

15. The method of claim 1, wherein determining the reference media data and generating the synchronized media data are performed concurrently.

16. The method of claim 1, wherein one or more of determining the reference media data or generating the synchronized media data is performed concurrently with video recording.

17. A non-transitory processor readable medium containing a set of instructions thereon for enhancing audio, wherein when executed by a processor, the instructions cause the processor to perform the method of claim 1.

18. An apparatus for enhancing audio, the apparatus comprising: one or more processors; and memory accessible by the one or more processors, the memory storing instructions that when executed by the one or more processors, cause the apparatus to perform the method of claim 1.

19. A computer-implemented method for enhancing audio, the method comprising:
receiving audio stream data, the audio stream data comprising non-media sounds and media sounds;
determining reference media data for the media sounds in the audio stream data;
generating synchronized media data based at least on the reference media data and the media sounds in the audio stream data; and
providing, to a device, at least one of the synchronized media data or data based on the synchronized media data to obtain an enhanced video.

20. The method of claim 19, further comprising:
generating reference canceled audio data based on the audio stream data and the synchronized media data; and
providing the reference canceled audio data to the device for combining the reference canceled audio data and the audio stream data to obtain the enhanced video.

21. The method of claim 19, further comprising:
generating reference enhanced audio data based on the audio stream data and the synchronized media data; and
providing the reference enhanced audio data to the device for combining the reference enhanced audio data and the audio stream data to obtain the enhanced video.

22. A non-transitory processor readable medium containing a set of instructions thereon for enhancing audio, wherein when executed by a processor, the instructions cause the processor to perform the method of claim 19.

23. An apparatus for enhancing audio, the apparatus comprising: one or more processors; and memory accessible by the one or more processors, the memory storing instructions that when executed by the one or more processors, cause the apparatus to perform the method of claim 19.

24. A computer-implemented method for enhancing audio, the method comprising:
generating or obtaining a recorded video, the recorded video comprising audio portion data and video portion data, the audio portion data comprising non-media sounds and media sounds;
receiving at least one of:
reference canceled audio data, the reference canceled audio data based on the media sounds of the audio portion data and synchronized to the audio portion data of the recorded video; or
reference enhanced audio data, the reference enhanced audio data based on the media sounds of the audio portion data and synchronized to the audio portion data of the recorded video;
adjusting audio of the recorded video based on at least one of the reference canceled audio data or the reference enhanced audio data to obtain enhanced audio; and
generating an enhanced video based on the recorded video and the enhanced audio.

25. The method of claim 24, further comprising:
displaying a user-selectable icon to generate or obtain the recorded video, wherein generating or obtaining the recorded video is based on receiving a selection of the user-selectable icon.

26. The method of claim 24, further comprising:
displaying, on the video recording screen, a user-selectable icon that enables a user to switch between generating a standard video and generating an enhanced video; and
generating the video in the mode selected via the user-selectable icon.

27. The method of claim 24, further comprising:
automatically selecting, during video generation, between generating a standard video and generating an enhanced video based on automatic content recognition of background media.

28. The method of claim 24, further comprising:
displaying at least one user-selectable icon to adjust audio of the recorded video, wherein adjusting audio of the recorded video is based on receiving a selection of the at least one user-selectable icon.

29. The method of claim 24, further comprising:
at least one of saving or sharing the enhanced video.

30. The method of claim 24, wherein the audio portion data of the recorded video was recorded by one or more microphones of a smartphone, tablet, or laptop, wherein the video portion data was recorded by a camera of the smartphone, tablet, or laptop.

31. A non-transitory processor readable medium containing a set of instructions thereon for enhancing audio, wherein when executed by a processor, the instructions cause the processor to perform the method of claim 24.

32. An apparatus for enhancing audio, the apparatus comprising: one or more processors; and memory accessible by the one or more processors, the memory storing instructions that when executed by the one or more processors, cause the apparatus to perform the method of claim 24.
